(19) United States
(12) Patent Application Publication
(10) Pub. No.: US 2011/0177440 A1
(43) Pub. Date: Jul. 21, 2011

(54) METHOD OF MANUFACTURING TONER AND TONER MANUFACTURED BY THE METHOD

(76) Inventors: Hiroshi Yamada, Shizuoka (JP); Akinori Saitoh, Shizuoka (JP); Masahide Yamada, Shizuoka (JP)

(21) Appl. No.: 13/009,179

(22) Filed: Jan. 19, 2011

(30) Foreign Application Priority Data
Jan. 21, 2010 (JP) 2010-011205
Jul. 16, 2010 (JP) 2010-161289
Nov. 8, 2010 (JP) 2010-249485

(51) Int. Cl. G03G 9/08

(52) U.S. Cl. 430/105; 430/137.1

(57) ABSTRACT

A method of manufacturing toner including: preparing a first liquid by dissolving or dispersing toner components including a colorant, a release agent, and one or both of a binder resin and a precursor thereof in an organic solvent; preparing a second liquid having a viscosity of from 50 to 800 mPa·sec when measured with a Brookfield viscometer at a revolution of 60 rpm and a temperature of 25° C., by emulsifying the first liquid in an aqueous medium; and evaporating the organic solvent from the second liquid by flowing down the second liquid as a liquid film from a supply part along an inner wall surface of a pipe depressurized to 70 kPa or less in substantially a vertical direction, and heating the liquid film at not higher than a glass transition temperature of the binder resin by contact with the inner wall surface of the pipe in a heating part. A heat insulating part is provided between the supply part and the heating part.

### CROSS-REFERENCE TO RELATED APPLICATIONS

The present patent application claims priority pursuant to 35 U.S.C. §119 from Japanese Patent Application Nos. 2010-011205, 2010-161289, and 2010-249485 filed on Jan. 21, 2010, Jul. 16, 2010, and Nov. 8, 2010, respectively, each of which is hereby incorporated by reference herein in its entirety.

### BACKGROUND

1. Field of the Invention

The present invention relates to a method of manufacturing toner for use in electrophotographic image forming apparatuses such as copiers, laser printers, and facsimile machines. In addition, the present invention also relates to a toner.

2. Description of the Background

To meet increasing demand for higher image quality, electrophotographic toners have been developed to have a narrower size distribution and a spherical shape. Because spherical toner particles with a narrow size distribution each behave in the same manner when developing an electrostatic image, the resulting toner image has high micro-dot reproducibility. In particular, spherical toner particles having a narrow size distribution and a small particle diameter are difficult to reliably remove with a blade member when they are undesirably remaining on an image bearing member.

By contrast, irregular-shaped toner particles, generally having low fluidity, are easy to remove with a blade member. However, because such irregular-shaped toner particles behave unstably when developing an electrostatic image, the resulting toner image has low micro-dot reproducibility. Because irregular-shaped toner particles are transferred onto a transfer medium at a low filling rate, the resulting toner layer on the transfer medium has a low thermal conductivity. Such a toner layer having a low thermal conductivity cannot be fixed on the transfer medium at low temperatures, especially when fixing pressure is relatively small.

Japanese Patent Application Publication No. (hereinafter JP-A) H09-15903 (corresponding to Japanese Patent No. 3473194) discloses a method of manufacturing toner including steps of mixing a binder resin and a colorant in a water-immiscible solvent, dispersing the resulting composition in an aqueous medium in the presence of a dispersion stabilizer, removing the solvent from the resulting suspension by applying heat and/or reducing pressure to form irregularities on the surfaces of the resulting particles, and spheroidizing or deforming the particles by applying heat. The resulting toner particles have unstable chargeability because their shapes are irregular.

JP-2005-49858-A discloses a method of manufacturing toner including steps of dispersing a solvent dispersion comprising a resin and/or a precursor thereof and a filler in an aqueous medium to prepare a W/O dispersion, and removing the solvent from the W/O dispersion to prepare resin particles. The W/O dispersion includes oil droplets, each of which includes an accumulation layer of the filler. The resulting toner particles are easily removable with a blade member because they have irregular shapes due to the presence of the accumulation layer of the filler on their surface. However, such toner particles cannot be fixed on a recoding medium at low temperatures due to the presence of the accumulation layer of the filler on their surface.

JP-2005-10723-A (corresponding to Japanese Patent No. 4030937) discloses a method of manufacturing toner including steps of dispersing an organic solvent solution or dispersion of toner components in an aqueous medium, introducing the resulting emulsion to a continuous vacuum defoaming device, and removing the organic solvent from the emulsion by applying shearing force. The resulting toner particles are easily removable with a blade member, and cause neither toner scattering in text images nor deterioration of line image reproducibility. However, in order to obtain spherical toner particles having a small particle diameter and a narrow particle diameter distribution, this method is required to further improve the efficiency of organic solvent removal.

Generally, when removing or evaporating an organic solvent from a resin composition including the organic solvent and a resin soluble in the resin to obtain the dried solid resin, the organic solvent is rapidly evaporated in the initial stage. However, the evaporating rate becomes gradually slower because a rigid resin layer is formed on the surface of the resin composition and gradually thickened as the organic solvent is evaporated. Therefore, it is very difficult to completely remove the organic solvent from such resin composition without adversely affecting the shape, structure, and properties of the resulting solid resin.

JP-H11-133665-A (corresponding to Japanese Patent No. 3762075) discloses a method of manufacturing toner including steps of dissolving binder resins comprising a urethane-modified polyester (i) and an unmodified polyester (ii) in a solvent, and dispersing the resulting solution in an aqueous medium.

JP-H11-149180-A (corresponding to Japanese Patent No. 3762079) discloses a method of manufacturing toner including steps of elongating and/or cross-linking a polyester prepolymer (A1) having an isocyanate group with an amine (B) in an aqueous medium to obtain a resin (i). The resulting toner includes the resin (i) and another resin (ii) inactive with either (A1) or (B) as binder resins.

JP-2000-292981 discloses a method of manufacturing toner in an aqueous medium. The resulting toner includes a high-molecular-weight resin (A) and a low-molecular-weight resin (B).

Each of the publications JP-H11-133665-A, JP-H11-149180-A, and JP-2000-292981 describes that the resulting toner has a good combination of heat-resistant storage stability, low-temperature fixability, hot offset resistance, and image gloss. However, in order to industrially manufacture spherical toner particles having a small particle diameter and a narrow particle diameter distribution, the above methods are required to further improve the efficiency of organic solvent removal.

### SUMMARY

Exemplary aspects of the present invention are put forward in view of the above-described circumstances, and provide a novel method of manufacturing a toner which reproduces micro-dots and is easily removable with a blade member.

In one exemplary embodiment, a novel method of manufacturing toner includes: preparing a first liquid by dissolving or dispersing toner components including a colorant, a release agent, and one or both of a binder resin and a precursor thereof in an organic solvent; preparing a second liquid having a viscosity of from 50 to 800 mPa·sec when measured with a Brookfield viscometer at a revolution of 60 rpm and a temperature of 25° C. by emulsifying the first liquid in an aqueous medium; and evaporating the organic solvent from the second liquid by flowing down the second liquid as a liquid film from a supply part along an inner wall surface of a pipe depressurized to 70 kPa or less in substantially a vertical direction and heating the liquid film at not higher than a glass transition temperature of the binder resin by contact with the inner wall surface of the pipe in a heating part. A heat insulating part is provided between the supply part and the heating part.

Other exemplary aspects of the present invention are put forward in view of the above-described circumstances, and provide a novel toner which is prepared by the above method.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 schematically illustrates a solvent removing apparatus according to exemplary embodiments;

FIG. 2 schematically illustrates another solvent removing apparatus according to exemplary embodiments;

FIGS. 3A and 3B are schematic views for explaining the shape factors SF-1 and SF-2, respectively;

FIG. 4 schematically illustrates an electrophotographic image forming apparatus to which a toner manufactured by the method according to this specification is applicable; and

FIG. 5 schematically illustrates a solvent removing apparatus used in Comparative Example 1.

### DETAILED DESCRIPTION

Exemplary aspects of the present invention provide a method of manufacturing toner including: preparing a first liquid by dissolving or dispersing toner components including a colorant, a release agent, and one or both of a binder resin and a precursor thereof in an organic solvent; preparing a second liquid having a viscosity of from 50 to 800 mPa·sec when measured with a Brookfield viscometer at a revolution of 60 rpm and a temperature of 25° C. by emulsifying the first liquid in an aqueous medium; and evaporating the organic solvent from the second liquid by flowing down the second liquid as a liquid film from a supply part along an inner wall surface of a pipe depressurized to 70 kPa or less in substantially a vertical direction and heating the liquid film at not higher than a glass transition temperature of the binder resin by contact with the inner wall surface of the pipe in a heating part, wherein a heat insulating part is provided between the supply part and the heating part.

In the above-described method, the precursor may comprise a compound having an active hydrogen group and a polymer having a functional group reactive with the active hydrogen group.

In the above-described method, a lower end of the pipe may project downward from the heating part.

In the above-described method, the following relationships may be satisfied:

T1≦T2

T2<Tg<T3

wherein T1 (° C.) represents a supply temperature of the second liquid, T2 (° C.) represents a temperature of the supply part, T3 (° C.) represents an emission temperature of a heat source, and Tg (° C.) represents a glass transition temperature of the binder resin.

In the above-described method, a portion of the discharged second liquid from which the organic solvent is evaporated may be returned to the supply part to form the liquid film together with the second liquid from which the organic solvent is not evaporated.

In the above-described method, the following relationships may be satisfied:

A+C=B

A=D+E

1.5A≦B≦20A

wherein A (kg/h) represents a supply flow rate of the second liquid from which the organic solvent is not evaporated, B (kg/h) represents a flow rate of the liquid film flowing down the inner wall surface of the pipe, C (kg/h) represents a flow rate of the portion of the discharged second liquid from which the organic solvent is evaporated that returns to the supply part, D (kg/h) represents a flow rate of a remaining discharged second liquid from which the organic solvent is evaporated that does not return to the supply part, and E (kg/h) represents an amount of the organic solvent evaporated from the second liquid.

The above-described methods efficiently manufacture a toner which reliably reproduces micro-dots and is easily removable with a blade member.

When the viscosity of the second liquid is less than 50 mPa·sec, the second liquid cannot be formed into a uniform liquid film when flowing down along an inner wall surface of the pipe in substantially a vertical direction. When the viscosity of the second liquid is greater than 800 mPa·sec, the liquid film may be too thick to efficiently evaporate the organic solvent.

The viscosity of the second liquid is controllable by adjusting the amount of solid components (or solvents) therein or adding an appropriate amount of layered inorganic compounds. Because the layered inorganic compounds also influence the average circularity of the resulting toner particles, it is more preferable that both the viscosity of the second liquid and the average circularity of the resulting toner particles are controlled by adjusting the amount of layered inorganic compounds to be added.

Preferably, firstly, the amount of solid components (or solvents) are roughly adjusted, secondly, the addition amount of layered inorganic compounds is adjusted to control the average circularity of the resulting toner particles, and thirdly, the amount of solid components (or solvents) are adjusted again to control the viscosity.

When the inner pressure of the pipe is greater than 70 kPa, it is difficult to efficiently evaporate the organic solvent. When the temperature of the second liquid flowing down the inner wall surface of the pipe (i.e., the inner temperature of the pipe) is greater than the glass transition temperature of the binder resin, the produced particles in the second liquid are likely to aggregate and accumulate at the supply part, preventing efficient evaporation of the organic solvent.

The heat insulating part provided between the supply part and the heating part stabilizes formation of the liquid film flowing down along the inner wall surface of the pipe, before the liquid film is heated. Additionally, the heat insulating part also prevents thermal conduction from the heating part to the supply part. If the temperature of the second liquid is increased at the supply part due to the thermal conduction, the viscosity of the second liquid may be undesirably changed, resulting in formation of nonuniform or thick liquid film. Also, the second liquid may be excessively heated above the glass transition temperature of the binder resin due to the thermal conduction, which results in undesirable aggregation of particles in the second liquid. Temperature increase of the second liquid at the supply part can be also prevented by cooling the heat insulating part.

As described above, the method according to this specification may satisfy the following relationships:

T1≦T2

T2<Tg<T3

wherein T1 (° C.) represents a supply temperature of the second liquid, T2 (° C.) represents a temperature of the supply part, T3 (° C.) represents an emission temperature of a heat source, and Tg (° C.) represents a glass transition temperature of the binder resin.

If T2 is lower than T1, the second liquid may lose its thermal energy at the supply part and may receive excessive thermal energy in the heating part, which is disadvantageous in terms of energy consumption.

The second liquid is heated to T2 at the supply part. If T2 is higher than Tg, liquid droplets in the second liquid may have too low viscosity, and therefore they may undesirably aggregate. When the produced particles are heated above the glass transition temperature thereof, they are likely to aggregate and accumulate at the supply part, resulting in unstable formation of liquid film or pipe clogging. Therefore, the temperature of the second liquid at the supply part, i.e., T2, is preferably equal to or greater than T1 and lower than Tg. This can be achieved by providing the heat insulating part between the supply part and the heating part.

In a case in which undesirable coarse particles are produced from the aggregations and are immixed in the second liquid, the resulting toner may not produce high quality images.

In another case in which adhesive substances are produced from the aggregations and are adhered to the inner wall surface of the pipe, the liquid film flow may be disturbed. As the adhesive substances thicken on the inner wall surface, heat-exchange capability of the inner wall surface deteriorates, preventing effective evaporation of the organic solvent.

As described above, the lower end of the pipe may project downward from the heating part to form a projection having a discharge opening for discharging the second liquid. In this case, the second liquid can be effectively discharged from the projection without accumulating at the lower end of the heating part.

In a case in which the second liquid accumulates at the discharge opening of the pipe while the projection is not formed, the discharge opening of the pipe is heated by the heating part to undesirably increase the local temperature of the accumulating second liquid. If the accumulating second liquid is heated above the glass transition temperature of the binder resin, the produced particles in the second liquid may undesirably aggregate and accumulate on the inner wall surface of the pipe.

Generally, a flow velocity of a fluid depends on the diameter of a pipe under a constant flow volume. The greater the cross-sectional area of the pipe, the smaller the flow velocity of the fluid. This is because the fluid receives more viscosity resistance from the pipe as the cross-sectional area of the pipe increases. Accordingly, in the method according to this specification, in which a liquid film of the second liquid flows down along an inner wall surface of a pipe for evaporating organic solvent, the flow velocity of the liquid film depends on the cross-sectional area of the pipe.

In a case in which the projection is not provided, in other words, the lower end of the heating part and the discharge opening of the pipe are on the same plane, the cross-sectional area of the pipe drastically changes at the discharge opening, and therefore the flow velocity of the liquid film drastically decreases at the discharge opening. As a result, liquid droplets in the second liquid are likely to accumulate at the lower end of the heating part. Because the lower end of the heating part is heated to a high temperature by a heat medium, the accumulating liquid droplets are heated to reduce their viscosity, resulting in formation of aggregations.

When the produced particles are heated above the glass transition temperature thereof, they are likely to aggregate and accumulate to cause pipe clogging. In a case in which undesirable coarse particles are produced from the resulting aggregations and are immixed in the second liquid, the resulting toner may not be capable of producing high quality images.

In another case in which adhesive substances are produced from the aggregations and are adhered to the inner wall surface of the pipe, the liquid film flow may be disturbed. As the adhesive substances thicken on the inner wall surface, heat-exchange capability of the inner wall surface deteriorates, preventing effective evaporation of the organic solvent.

The above problems caused by undesirable aggregations can be solved by providing the projection that is formed by projecting the lower end of the pipe downward from the heating part.

As described above, the projection prevents accumulation of the second liquid at the lower end of the heating part. Additionally, the projection also prevents thermal conduction from the heating part to the discharge opening owing to the relatively long distance therebetween. Thus, accumulation of aggregations can be prevented.

Preferably, the projection has a length equal to or greater than the diameter of the pipe, more preferably, greater than 3 times the diameter of the pipe. When the length of the projection is smaller than the diameter of the pipe, the liquid film may drastically reduce its flow velocity and liquid droplets may accumulate at the lower end of the heating part. Because the lower end of the heating part is heated to a high temperature by a heat medium, the accumulating liquid droplets are heated to reduce their viscosity, resulting in formation of aggregations. When the length of the projection is greater than 20 times the diameter of the pipe, it makes the apparatus larger and increases pressure loss.

The method according to this specification may satisfy the following relationship:

V2≧V1

wherein V1 (m/sec) represents a linear velocity of the liquid film flowing down along the inner wall surface of the pipe within the heating part, and V2 (m/sec) represents a linear velocity of the liquid film at the discharge opening.

V2 (m/sec), i.e., the linear velocity of the liquid film at the discharge opening can be increased by, for example, forming an end of the discharge opening aslant so that the liquid easily drops; making the surface roughness of the inner wall surface of the pipe at the discharge opening smaller than that at the heating part so that the liquid smoothly discharges; using a different material for the pipe at the discharge opening; or narrowing the diameter of the pipe at the projection than that at the heating part.

By increasing the linear velocity of the liquid film at the discharge opening, accumulation and aggregation of the second liquid at the lower end of the heating part or the discharge opening of the pipe can be prevented.

As described above, a portion of the discharged second liquid from which the organic solvent is evaporated may be returned to the supply part to form the liquid film together with the second liquid from which the organic solvent is not evaporated. The resupplied second liquid may be hereinafter referred to as the circulating liquid.

In such a case, the following relationships may be satisfied:

A+C=B

A=D+E

wherein A (kg/h) represents a supply flow rate of the second liquid from which the organic solvent is not evaporated, B (kg/h) represents a flow rate of the liquid film flowing down the inner wall surface of the pipe, C (kg/h) represents a flow rate of the portion of the discharged second liquid from which the organic solvent is evaporated that returns to the supply part (i.e., the circulating liquid), D (kg/h) represents a flow rate of a remaining discharged second liquid from which the organic solvent is evaporated that does not return to the supply part, and E (kg/h) represents an amount of the organic solvent evaporated from the second liquid.

Additionally, the following relationships are preferably satisfied:

1.5A≦B

0.5A≦C

When B (kg/h) is less than 0.5A (kg/h), the liquid film may receive excessive heat from the heat source so that the organic solvent is excessively evaporated to increase the viscosity. As a result, the lower part of the inner wall surface of the pipe may be insufficiently wetted, causing pipe clogging.

Moreover, the following relationships are preferably satisfied:

B≦20A

C≦19A

When B (kg/h) is greater than 20A (kg/h), the amount of circulating liquid may increase, and therefore the amount of heat and solid components in the liquid film may also increase. The circulating liquid is more condensed as the organic solvent is evaporated. The condensed slurry has a high viscosity because of including the solid components at a high concentration, which is hard to handle. In view of this, B≦20A is preferably satisfied.

When the condensed circulating liquid and the second liquid has a significant difference in composition, the mixture of the circulating liquid and the second liquid may not sufficiently wet the inner wall surface of the pipe. Thus, particles in the second liquid may aggregate and accumulate on the inner wall surface of the pipe, thereby preventing efficient evaporation of the organic solvent.

The outer surface of the pipe is heated for controlling the temperature of the liquid film. One exemplary procedure of controlling the temperature of the liquid film includes, for example, providing an outer pipe and an inner pipe in which the liquid film flows down along an inner wall surface thereof, and supplying a heat medium between the outer pipe and the inner pipe. Thus, the second liquid can be controlled by contact with the wall surface of the inner pipe to have a temperature not higher than the glass transition temperature of the binder resin.

Exemplary aspects of the present invention also provide a solvent removing apparatus for use in toner manufacture. The solvent removing apparatus may include, for example, a supply part that supplies the second liquid, a heating part, and a container. The heating part heats an outer wall surface of a pipe so that the second liquid film flowing down along an inner wall surface of the pipe is heated and the organic solvent is evaporated from the second liquid. The heating part preferably includes an inner pipe and an outer pipe, between which a heat medium is supplied for heating the second liquid film flowing down along an inner wall surface of the pipe, to more reliably control the temperature of the second liquid.

Exemplary embodiments of the present invention are described in detail below with reference to accompanying drawings. In describing exemplary embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

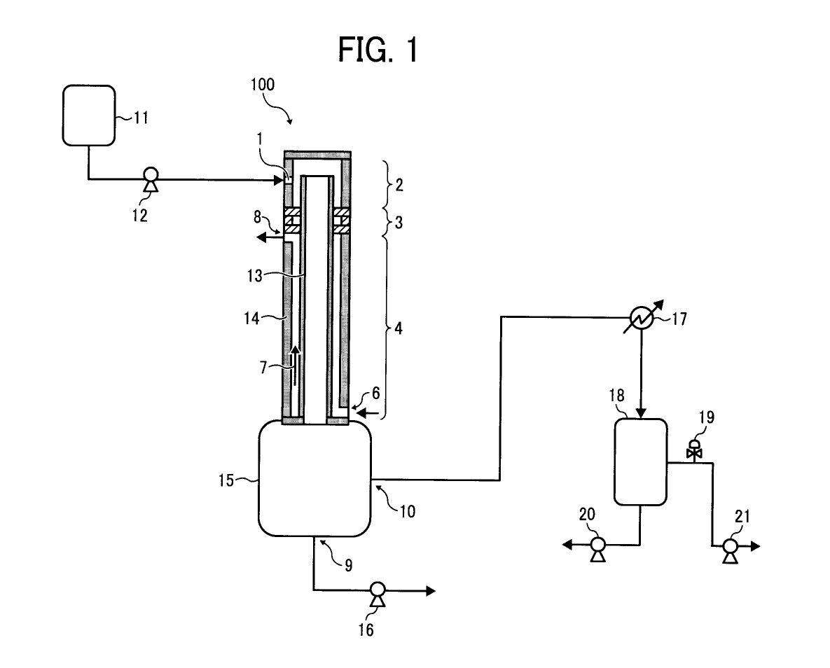

FIG. 1 schematically illustrates a solvent removing apparatus according to exemplary embodiments.

A solvent removing apparatus 100 illustrated in FIG. 1 includes a supply part 2, a heat insulating part 3, and a heating part 4. The apparatus 100 further includes an outer pipe 14 that defines outlines of the supply part 2, the heat insulating part 3, and the heating part 4; and an inner pipe 13 that penetrates the heat insulating part 3 and the heating part 4 while connecting the supply part 2 to a tank 15. The second liquid is supplied from a second liquid tank 11 through a supply opening 1 provided in the supply part 2 and flows down along an inner wall surface of the inner pipe 13, thus accumulating in the tank 15.

A space between the inner pipe 13 and the outer pipe 14 is filled with a heat medium 7 supplied from a heat medium inlet 6 and discharged from a heat medium outlet 8, so that an outer wall surface of the inner pipe 13 is heated. Further, the inner pipe 13 is depressurized to 70 kPa or less by a vacuum pump 21 when evaporating organic solvent. The second liquid is supplied from the supply opening 1 provided on an upper surface of the inner pipe 13, and then formed into a liquid film that flows down along an inner wall surface of the inner pipe 13 in substantially a vertical direction. The liquid film is controlled to have a temperature lower than the glass transition temperature of the binder resin by contact with the inner wall surface of the inner pipe 13, so that the produced particles may not soften or aggregate. Thus, the organic solvent can be efficiently removed from the second liquid.

The heat insulating part 3 prevents thermal conduction from the heating part 4 to the supply part 2. Thus, even when the second liquid remains at a bottom of the supply part 2, the second liquid does not increase its temperature.

Both the organic solvent evaporated from the second liquid in the inner pipe 13, in the form of gas, and the discharged second liquid from which the organic solvent is evaporated, in the form of liquid, accumulate in the tank 15. The liquid is discharged from a discharge opening 9 by a discharge pump 16. The gas is discharged from a gas outlet 10, condensed in a condenser 17, accumulated in a condensate liquid tank 18, and discharged therefrom by a condensate liquid discharge pump 20. Both the vacuum pump 21 and a pressure regulating valve 19 control the gas-liquid equilibrium so as to establish a desired degree of pressure reduction. Thus, the organic solvent is removed from the second liquid at a temperature not higher than the glass transition temperature of the binder resin.

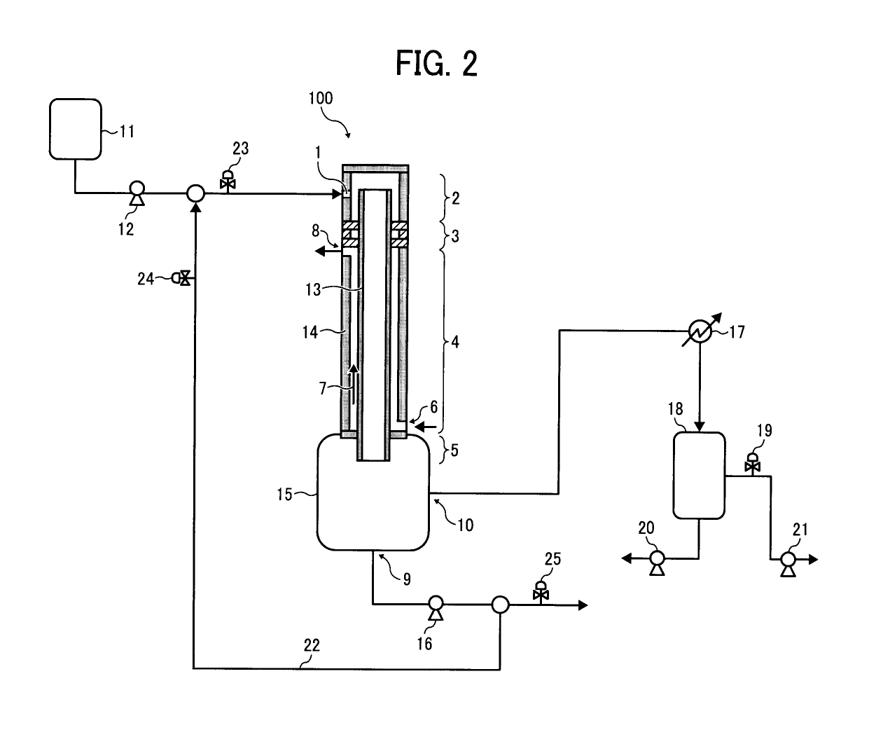

FIG. 2 schematically illustrates another solvent removing apparatus according to exemplary embodiments.

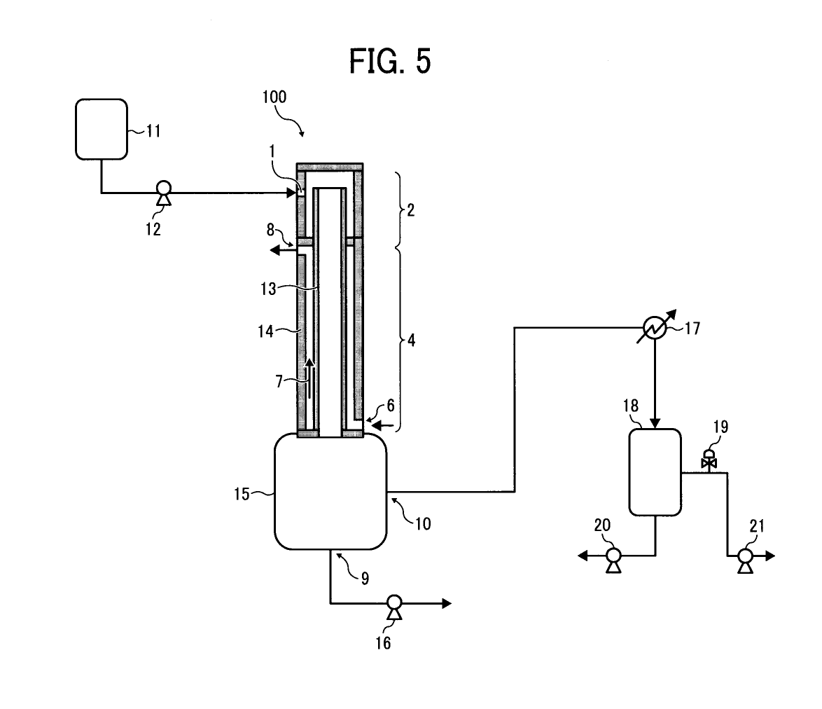

In FIG. 5, a lower part of the inner pipe 13 projects downward from the heating part 4 to form a projection 5.

The second liquid is immediately discharged from the heating part 4 through the projection 5 after receiving a necessary thermal energy for evaporating the organic solvent. Thus, excessive temperature increase of the second liquid is prevented. If the projection 5 is not provided, liquid droplets in the second liquid may accumulate on a lower part of the inner pipe 13 and fuse thereon due to thermal conduction from the heating part 4, probably causing clogging after a long period of use.

A portion of the discharged second liquid from which the organic solvent is evaporated is resupplied to the supply opening 1 through a return path 22. The resupplied second liquid may be hereinafter referred to as the circulating liquid. The circulating liquid joins the second liquid at the supply opening 1 and together flows down along the inner wall surface of the inner pipe 13 in substantially a vertical direction while forming a liquid film.

When the initial concentration of the organic solvent in the liquid film is too high, the liquid film may considerably increase its viscosity as the organic solvent is evaporated. As a result, a lower part of the inner wall surface of the inner pipe 13 cannot be wetted, generating dry spots. The second liquid may selectively adhere to the dry spots and probably cause clogging after a long period of use.

A supply pump 12 controls the supply amount of the second liquid. The discharge pump 16 controls the discharge amount of the discharged second liquid from which the organic solvent is removed. Back pressure valves 23, 24, and 25 control the resupply amount of the circulating liquid and the discharge amount of the remaining discharged second liquid from which the organic solvent is removed by controlling the pressure differences thereamong.

In the above-described embodiment, it is preferable that the circulating liquid joins the second liquid so that the organic solvent is reliably evaporated during a steady state operation. For example, in one exemplary operation procedure, only the second liquid is supplied to the inner pipe 13 at the initial stage of the operation, and after the discharge pump 16 starts discharging the discharged second liquid from which the organic solvent is removed from the tank 15, both the second liquid and the circulating liquid are supplied to the inner pipe 13, thus reaching the steady state operation during which the organic solvent is reliably evaporated.

Alternatively, in another exemplary operation procedure, the tank 15 is previously filled with ion-exchange water or the aqueous medium used for the second liquid, and the discharge pump 16 supplies, from the initial stage of the operation, ion-exchange water or the aqueous medium as the circulating liquid to the inner pipe 13 along with the second liquid.

As described above, the first liquid includes a binder resin and/or a precursor thereof. Alternatively, the first liquid may include a binder resin and/or a combination of a compound having an active hydrogen group and a polymer having a functional group reactive with the active hydrogen group.

In the latter case, it is preferable that the compound having an active hydrogen group reacts with the polymer having a functional group reactive with the active hydrogen group in while the second liquid is prepared.

Preferably, the polymer having a functional group reactive with the active hydrogen group is a polyester having an isocyanate group, but is not limited thereto. This polyester may be hereinafter referred to as a prepolymer (A).

The active hydrogen group in the compound may be, for example, a hydroxyl group (e.g., an alcoholic hydroxyl group, a phenolic hydroxyl group), an amino group, a carboxyl group, or a mercapto group. Among these hydroxyl groups, alcoholic hydroxyl groups and amino groups are preferable.

The following description is based on an exemplary combination of the prepolymer (A) as the polymer having a functional group reactive with the active hydrogen group, and an amine (B) as the compound having an active hydrogen group.

The prepolymer (A) reacts with the amine (B) to produce an urea-modified polyester. Because the amine (B) functions as a cross-linking agent and/or an elongating agent, it is easy to control the molecular weight of high-molecular-weight components in the resultant urea-modified resin. A toner including such an urea-modified polyester can be advantageously fixed on a recording medium at low temperatures without applying oil to a fixing member, while keeping high fluidity and transparency. In particular, an urea-modified polyester, the terminals of which are modified with a urea group, is more advantageous.

The prepolymer (A) can be obtained by reacting a polyester having an active hydrogen group with a polyisocyanate (PIC). The active hydrogen group in the polyester may be, for example, a hydroxyl group (e.g., an alcoholic hydroxyl group, a phenolic hydroxyl group), an amino group, a carboxyl group, or a mercapto group. Among these hydroxyl groups, alcoholic hydroxyl groups are preferable.

A polyester having an alcoholic hydroxy group can be obtained by polycondensation between a polyol (PO) and a polycarboxylic acid (PC).

The polyol (PO) may be, for example, a diol (DIO) or a polyol (TO) having 3 or more valences. A diol (DIO) alone or a mixture of a diol (DIO) and a polyol (TO) having 3 or more valences are preferable.

Specific examples of the diol (DIO) include, but are not limited to, alkylene glycols (e.g., ethylene glycol, 1,2-propylene glycol, 1,3-propylene glycol, 1,4-butanediol, 1,6-hexanediol), alkylene ether glycols (e.g., diethylene glycol, triethylene glycol, dipropylene glycol, polyethylene glycol, polypropylene glycol, polytetramethylene ether glycol), alicyclic diols (e.g., 1,4-cyclohexanedimethanol, hydrogenated bisphenol A), bisphenols (e.g., bisphenol A, bisphenol F, bisphenol S), alkylene oxide (e.g., ethylene oxide, propylene oxide, butylene oxide) adducts of the alicyclic diols, and alkylene oxide (e.g., ethylene oxide, propylene oxide, butylene oxide) adducts of the bisphenols. Two or more of these diols can be used in combination.

Among the above diols, alkylene glycols having 2 to 12 carbon atoms and alkylene oxide adducts of bisphenols are preferable; and alkylene oxide adducts of bisphenols and mixtures of an alkylene oxide adducts of bisphenol with an alkylene glycol having 2 to 12 carbon atoms are more preferable.

Specific examples of the polyol (TO) having 3 or more valences include, but are not limited to, polyvalent aliphatic alcohols (e.g., glycerin, trimethylolethane, trimethylolpropane, pentaerythritol, sorbitol), polyphenols (e.g., trisphenol PA, phenol novolac, cresol novolac), and alkylene oxide (e.g., ethylene oxide, propylene oxide, butylene oxide) adducts of the polyphenols.

The polycarboxylic acid (PC) may be, for example, a dicarboxylic acid (DIC) or a polycarboxylic acid (TC) having 3 or more valences. A dicarboxylic acid (DIC) alone or a mixture of a dicarboxylic acid (DIC) and polycarboxylic acid (TC) having 3 or more valences are preferable.

Specific examples of the dicarboxylic acid (DIC) include, but are not limited to, alkylene dicarboxylic acids (e.g., succinic acid, adipic acid, sebacic acid), alkenylene dicarboxylic acids (e.g., maleic acid, fumaric acid), and aromatic dicarboxylic acids (e.g., phthalic acid, isophthalic acid, terephthalic acid, naphthalenedicarboxylic acid). Two or more of these dicarboxylic acids can be used in combination. Among these dicarboxylic acids, alkenylene dicarboxylic acids having 4 to 20 carbon atoms and aromatic dicarboxylic acids having 8 to 20 carbon atoms are preferable.

Specific examples of the polycarboxylic acid (TC) having 3 or more valences include, but are not limited to, aromatic polycarboxylic acids (e.g., trimellitic acid, pyromellitic acid). Two or more of these polycarboxylic acids can be used in combination.

Additionally, anhydrides and lower alkyl esters (e.g., methyl ester, ethyl ester, isopropyl ester) of polycarboxylic acids (PC) are also usable as the polycarboxylic acid (PC).

Preferably, the polyester having an alcoholic hydroxy group is obtained in the presence of an esterification catalyst (e.g., tetrabutoxy titanate, dibutyltin oxide) at 150 to 280° C., while optionally reducing pressure and removing the produced water. The equivalent ratio of hydroxyl groups in the polyol to carboxyl groups in the polycarboxylic acid is preferably from 1 to 2, more preferably from 1 to 1.5, and most preferably from 1.02 to 1.3.

Specific examples of suitable polyisocyanates (PIC) include, but are not limited to, aliphatic polyisocyanates (e.g., tetramethylene diisocyanate, hexamethylene diisocyanate, 2,6-diisocyanatomethyl caproate), alicyclic polyisocyanates (e.g., isophorone diisocyanate, cyclohexylmethane diisocyanate), aromatic diisocyanates (e.g., tolylene diisocyanate, diphenylmethane diisocyanate), aromatic aliphatic diisocyanates (e.g., α,α,α′,α′-tetramethylxylylene diisocyanate), isocyanurates, and polyisocyanates in which the isocyanate group is blocked with a phenol derivative, an oxime, or caprolactam. Two or more of these polyisocyanates can be used in combination.

Preferably, the polyester having an alcoholic hydroxyl group is reacted with the polyisocyanate (PIC) at 40 to 140° C. The equivalent ratio of isocyanate groups in the polyisocyanate to alcoholic hydroxyl groups in the polyester is preferably from 1 to 5, more preferably from 1.2 to 4, and most preferably from 1.5 to 2.5. When the equivalent ratio is too large, the resulting toner may have poor low-temperature fixability. When the equivalent ratio is too small, the resulting urea-modified polyester may include too small an amount of urea groups, resulting in a toner having poor hot offset resistance.

The polyester having an alcoholic hydroxyl group can be reacted with the polyisocyanate (PIC) in the presence of a solvent, if needed. Specific examples of usable solvents include, but are not limited to, aromatic solvents (e.g., toluene, xylene), ketones (e.g., acetone, methyl ethyl ketone, methyl isobutyl ketone), esters (e.g., ethyl acetate), amides (e.g., dimethylformamide, dimethylacetamide), and ethers (e.g., tetrahydrofuran), which are inactive with isocyanates.

The prepolymer (A) preferably has a weight average molecular weight of from 3,000 to 20,000. When the weight average molecular weight is too small, it may be difficult to control the reaction speed between the prepolymer (A) and the amine (B) and to reliably produce an urea-modified polyester. When the weight average molecular weight is too large, the prepolymer (A) may not sufficiently react with the amine, resulting in a toner having poor hot offset resistance.

The prepolymer (A) preferably includes polyisocyanate-origin units in an amount of from 0.5 to 40% by weight, more preferably from 1 to 30% by weight, and most preferably from 2 to 20% by weight. When the amount of polyisocyanate-origin units is too small, the resulting toner may have poor hot offset resistance, heat-resistance storage stability, and low-temperature fixability. When the amount of polyisocyanate-origin units is too large, the resulting toner may have poor low-temperature fixability.

The average number of isocyanate groups included in one molecule of the prepolymer (A) is preferably 1 or more, more preferably from 1.5 to 3, and most preferably from 1.8 to 2.5. When the number of isocyanate groups is too small, the resulting urea-modified polyester may have too small a molecular weight, and therefore the resulting toner may have poor hot offset resistance.

The amine (B) may be, for example, a diamine (B1), a polyamine (B2) having 3 or more valences, an amino alcohol (B3), an amino mercaptan (B4), or an amino acid (B5), and a blocked amine (B6) in which the amino group is blocked. Among these amines, a diamine (B1), and a mixture of a diamine (B1) and a polyamine (B2) having 3 or more valences are preferable.

Specific examples of usable diamines (B1) include, but are not limited to, aromatic diamines (e.g., phenylenediamine, diethyltoluenediamine, 4,4′-diaminophenylmethane), alicyclic diamines (e.g., 4,4′-diamino-3,3′-dimethyldicyclohexylmethane, diaminocyclohexane, isophoronediamine), and aliphatic diamines (e.g., ethylenediamine, tetramethylenediamine, hexamethylenediamine). Two or more of them can be used in combination.

Specific examples of usable polyamines (B2) having 3 or more valences include, but are not limited to, diethylenetriamine and triethylenetetramine. Two or more of them can be used in combination.

Specific examples of usable amino alcohols (B3) include, but are not limited to, ethanolamine and hydroxyethylaniline. Two or more of them can be used in combination.

Specific examples of usable amino mercaptans (B4) include, but are not limited to, aminoethyl mercaptan and aminopropyl mercaptan. Two or more of them can be used in combination.

Specific examples of usable amino acids (B5) include, but are not limited to, aminopropionic acid and amino caproic acid. Two or more of them can be used in combination.

Specific examples of usable blocked amines (B6) include, but are not limited to, ketimine compounds obtained from amines and ketones (e.g., acetone, methyl ethyl ketone, methyl isobutyl ketone), and oxazoline compounds. Two or more of them can be used in combination.

The prepolymer (A) may react with the amine (B) in the presence of a catalyst (e.g. dibutyltin laurate, dioctyltin laurate), if needed. The reaction time between the prepolymer (A) and the amine (B) is preferably from 10 minutes to 40 hours, and more preferably from 2 to 24 hours. The reaction temperature is preferably from 0 to 150° C., and more preferably from 40 to 98° C.

When reacting the prepolymer (A) with the amine (B), the equivalent ratio of isocyanate groups in the prepolymer (A) to amino groups in the amine (B) is preferably from 0.5 to 2, more preferably from 2/3 to 1.5, and most preferably from 5/6 to 1.2. When the equivalent ratio is too large or small, the resulting urea-modified polyester may have too small a molecular weight, resulting in a toner having poor hot offset resistance.

The reaction between the prepolymer (A) and the amine (B) may be terminated with a reaction terminator for the purpose of controlling the molecular weight of the resulting urea-modified polyester.

Specific preferred examples of suitable reaction terminators include, but are not limited to, monoamines (e.g., diethylamine, dibutylamine, butylamine, laurylamine) and those in which the amino group is blocked (e.g., ketimine compounds).

The first liquid may include a modified polyester (e.g., a urea-modified polyester, a urethane-modified polyester) either in place of or in combination with the prepolymer (A).

A urea-modified polyester can be obtained by, for example, reacting the prepolymer (A) with the amine (B), optionally in the presence of a catalyst (e.g., dibutyltin laurate, dioctyltin laurate). In this case, the reaction time is preferably from 10 minutes to 40 hours, and more preferably from 2 to 24 hours. The reaction temperature is preferably from 0 to 150° C., and more preferably from 40 to 98° C.

When reacting the prepolymer (A) with the amine (B), the equivalent ratio of isocyanate groups in the prepolymer (A) to amino groups in the amine (B) is preferably from 0.5 to 2, more preferably from 2/3 to 1.5, and most preferably from 5/6 to 1.2. When the equivalent ratio is too large or small, the resulting urea-modified polyester may have too small a molecular weight, resulting in a toner having poor hot offset resistance.

The reaction between the prepolymer (A) and the amine (B) may be terminated with a reaction terminator for the purpose of controlling the molecular weight of the resulting urea-modified polyester.

Specific preferred examples of suitable reaction terminators include, but are not limited to, monoamines (e.g., diethylamine, dibutylamine, butylamine, laurylamine) and those in which the amino group is blocked (e.g., ketimine compounds).

The prepolymer (A) can be reacted with the amine (B) in the presence of a solvent, if needed. Specific examples of usable solvents include, but are not limited to, aromatic solvents (e.g., toluene, xylene), ketones (e.g., acetone, methyl ethyl ketone, methyl isobutyl ketone), esters (e.g., ethyl acetate), amides (e.g., dimethylformamide, dimethylacetamide), and ethers (e.g., tetrahydrofuran), which are inactive with isocyanates.

The amount of the solvent is preferably from 0 to 300 parts by weight, more preferably from 0 to 100 parts by weight, and most preferably from 25 to 75 parts by weight, based on 100 parts by weight of the prepolymer (A).

The urea-modified polyester may include urethane bonds other than urea bonds. The molar ratio of urethane bonds to urea bonds is preferably from 0 to 9, more preferably from 0.25 to 4, and most preferably from 2/3 to 7/3. When the molar ratio is greater than 9, the resulting toner may have poor hot offset resistance.

The modified polyester preferably has a weight average molecular weight of 10,000 or more, more preferably from 20,000 to 1,000,000, and most preferably from 30,000 to 100,000. When the weight average molecular weight is too small, the resulting toner may have poor hot offset resistance.

When the first liquid does not include a polyester resin, the modified polyester preferably has a number average molecular weight of from 2,000 to 15,000, more preferably from 2,000 to 10,000, and most preferably from 2,000 to 8,000. When the number average molecular weight is too small, the resulting toner image on a paper may wind around a fixing roller. When the number average molecular weight is too large, the resulting toner may not be fixed at low temperatures and the resulting toner image may have low gloss.

Further, the first liquid may include a polyester either in place of or in combination with the prepolymer (A), to provide a toner having a good combination of heat-resistant storage stability and low-temperature fixability.

The polyester can be obtained by polycondensation between the polyol (PO) and the polycarboxylic acid (PC).

THF-soluble components in the polyester preferably have a weight average molecular weight of from 1,000 to 30,000. When the weight average molecular weight of THF-soluble components is too small, the polyester includes a large amount of oligomers, and therefore the resulting toner may have poor heat-resistant storage stability. When the weight average molecular weight of THF-soluble components is too large, and such a polyester is used in combination with the prepolymer (A), the prepolymer (A) cannot sufficiently react with the amine (B) due to steric hindrance. Therefore, the resulting toner may have poor offset resistance.

The number and weight average molecular weights are converted from molecular weights of polystyrenes measured by gel permeation chromatography (GPC).

The polyester preferably has an acid value of from 1 to 50 KOHmg/g. When the acid value is too small, a basic compound cannot exert its dispersion stabilizing effect in toner manufacturing processes. Moreover, when the polyester is included in the first liquid along with the prepolymer (A) and the amine (B), it is likely that the reaction between the prepolymer (A) and the amine (B) proceeds too much, resulting in poor manufacturing stability. When the acid value is too large and the polyester is included in the first liquid along with the prepolymer (A) and the amine (B), it is likely that the reaction between the prepolymer (A) and the amine (B) insufficiently proceeds, resulting in a toner having poor offset resistance.

The acid value can be measured based on a method according to JIS K0070-1992.

The polyester preferably has a glass transition temperature of from 35 to 65° C. When the glass transition temperature is too low, the resulting toner may have poor heat-resistant storage stability. When the glass transition temperature is too high, the resulting toner may have poor low-temperature fixability.

A toner including both the urea-modified polyester and the polyester has a good combination of low-temperature fixability and high glossiness. Such a toner can be obtained through a process, for example, in which the polyester is dissolved in a solution in which the prepolymer (A) is reacting with the amine (B). The toner may also include a urea-modified polyester in combination with the urea-modified polyester.

In terms of low-temperature fixability and hot offset resistance, it is preferable that the urea-modified polyester and the polyester are at least partially compatible with each other. Therefore, it is preferable that the urea-modified polyester and the polyester have a similar chemical composition.

The weight ratio of the urea-modified polyester to the polyester is preferably from 5/95 to 80/20, more preferably from 5/95 to 30/70, much more preferably from 5/95 to 25/75, and most preferably from 7/93 to 20/80. When the weight ratio is too small, the resulting toner may have poor hot offset resistance, heat-resistant storage stability, and low-temperature fixability. When the weight ratio is too large, the resulting toner may have poor low-temperature fixability.

The content of the polyester in the total binder resin is preferably from 50 to 100% by weight. When the content of the polyester is too small, the resulting toner may have poor heat-resistant storage stability and low-temperature fixability.

The toner components preferably include a modified layered inorganic mineral in which metallic cations are at least partially exchanged with an organic cation.

For example, the modified layered inorganic mineral may be a layered inorganic mineral having a smectite-type basic crystal structure in which metallic cations are at least ion-exchanged with an organic cation. Such modified layer inorganic minerals control the shape of the resulting toner and improve chargeability of the resulting toner.

Specific examples of suitable layered inorganic minerals include, but are not limited to, montmorillonite, bentonite, beidellite, nontronite, saponite, and hectorite. Two or more of these layered inorganic minerals can be used in combination.

Specific examples of suitable organic cations include, but are not limited to, quaternary ammonium ions, phosphonium ions, and imidazolinium ions. Among these organic cations, quaternary ammonium ions are preferable.

Specific examples of suitable quaternary ammonium ions include, but are not limited to, trimethyl stearyl ammonium ion, dimethyl stearyl benzyl ammonium ion, dimethyl octadecyl ammonium ion, oleyl bis(2-hydroxyethyl) methyl ammonium ion.

Specific examples of commercially available modified layered inorganic minerals include, but are not limited to, BENTONE® 34, BENTONE® 52, BENTONE® 38, BENTONE® 27, BENTONE® 57, BENTONE® SD1, BENTONE® SD2, and BENTONE® SD3 (from Elementis Specialities); CLAYTONE® 34, CLAYTONE® 40, CLAYTONE® HT, CLAYTONE® 2000, CLAYTONE® AF, CLAYTONE® APA, and CLAYTONE® HY (from Southern Clay Products); S-BEN, S-BEN E, S-BEN C, S-BEN NZ, S-BEN NZ70, S-BEN W, S-BEN N400, S-BEN NX, S-BEN NX80, S-BEN NO12S, S-BEN NEZ, S-BEN NO12, S-BEN WX, and S-BEN NE (from HOJUN Co., Ltd.); and KUNIBIS 110, 120, and 127 (from Kunimine Industries Co., Ltd.)

Preferably, the modified layered inorganic mineral is mixed and combined with the binder resin to be a composite (hereinafter “master batch”), before added to the first liquid. The master batch can be prepared by mixing the modified layered inorganic mineral and the binder resin and kneading the mixture while applying a high shearing force thereto. An organic solvent can be further added to the mixture to increase the interaction between the modified layered inorganic mineral and the binder resin. When performing the mixing and kneading, a dispersing device capable of applying a high shearing force such as a three roll mill is preferably used.

Alternatively, the master batch can be prepared by a flushing method in which an aqueous paste including the modified layered inorganic mineral is mixed and kneaded with the binder resin and an organic solvent so that the modified layered inorganic mineral is transferred to the binder resin side, and then the organic solvent and moisture contents are removed. Advantageously, the resulting wet cake of the modified layered inorganic mineral can be used as it is without being dried.

The modified layered inorganic mineral preferably has a volume average particle diameter of from 0.1 to 0.55 μm in the master batch. When the volume average particle diameter is too small or large, the shape and chargeability of the resulting toner cannot be sufficiently controlled.

Additionally, the content of the modified layered inorganic mineral having a volume average particle diameter of 1 μm or more in the master batch is preferably from 0 to 15% by volume. When the content of the modified layered inorganic mineral having a volume average particle diameter of 1 μm or more is too large, the shape and chargeability of the resulting toner cannot be sufficiently controlled.

The toner preferably includes the modified layered inorganic mineral in an amount of from 0.1 to 5% by weight. When the amount of the modified layered inorganic mineral is too small, the shape and chargeability of the resulting toner cannot be sufficiently controlled. When the amount of the modified layered inorganic mineral is too large, fixability of the resulting toner may be poor.

Specific examples of usable colorants include, but are not limited to, carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, and lithopone. Two or more of these colorants can be used in combination.

The content of the colorant in the toner is preferably from 1 to 15% by weight, more preferably from 3 to 10% by weight.

The colorant can be combined with a resin to be used as a master batch. The master batch can be prepared by mixing a resin and the colorant and kneading the mixture while applying a high shearing force thereto. An organic solvent can be further added to the mixture to increase the interaction between the colorant and the resin. When performing the mixing and kneading, a dispersing device capable of applying a high shearing force such as a three roll mill can be preferably used.

Alternatively, the master batch can be prepared by a flushing method in which an aqueous paste including the colorant is mixed and kneaded with the resin and an organic solvent so that the colorant is transferred to the resin side, followed by removal of the organic solvent and moisture contents. Advantageously, the resulting wet cake of the colorant can be used as it is without being dried.

Specific examples of suitable resin for the master batch include, but are not limited to, the above-described modified polyester and polyester, styrene homopolymers (e.g., polystyrene, poly-p-chlorostyrene, polyvinyl toluene), styrene copolymers (e.g., styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl α-chloromethacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, styrene-maleate copolymer), polymethyl methacrylate, polybutyl methacrylate, polyvinyl chloride, polyvinyl acetate, polyethylene, polypropylene, epoxy resins, epoxy polyol resins, polyurethane, polyamide, polyvinyl butyral, polyacrylic acids, rosin, modified rosin, terpene resins, aliphatic or alicyclic hydrocarbon resins, aromatic petroleum resin, chlorinated paraffin, and paraffin wax. Two or more of such resins can be used in combination.

Specific examples of usable release agents include, but are not limited to, plant waxes (e.g., carnauba wax, cotton wax, sumac wax, rice wax), animal waxes (e.g., bees wax, lanoline), mineral waxes (e.g., ozokerite, ceresin), petroleum waxes (e.g., paraffin, microcrystalline, petrolatum), synthetic hydrocarbon waxes (e.g., Fischer-Tropsch wax, polyethylene wax), and synthetic waxes (e.g., ester, ketone, ether). Two or more of these release agents can be used in combination.

Additionally, fatty acid amides (e.g., 12-hydroxystearamide, stearamide, phthalimide anhydride, chlorinated hydrocarbon), low-molecular-weight crystalline polymers (e.g., homopolymers of polyacrylates such as poly-n-stearyl methacrylate and poly-n-lauryl methacrylate, and copolymers of polyacrylates such as n-stearyl acrylate-ethyl methacrylate copolymer), and crystalline polymers having a side chain having a long-chain alkyl group, are also usable as the release agent.

The release agent preferably has a melting point of from 50 to 120° C. Such a release agent improves hot offset resistance of the resulting toner even when no oil is applied to a fixing member. The melting point of the release agent can be determined from a maximum endothermic peak measured by differential scanning calorimetry (DSC).

The toner preferably includes the release agent in an amount of from 1 to 20% by weight.

The first liquid includes an organic solvent. Because the organic solvent is finally removed by evaporation, the organic solvent preferably has a boiling point less than 100° C. Specific preferred examples of such organic solvents include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. Two or more of these solvents can be used in combination. Among these solvents, aromatic solvents (e.g., toluene, xylene) and halogenated hydrocarbons (e.g., methylene chloride, 1,2-dichlorethane, chloroform, carbon tetrachloride) are preferable.

When the binder resin and/or a precursor thereof (e.g., a compound having an active hydrogen group and a polymer having a functional group reactive with the active hydrogen group) are soluble in the organic solvent, the first liquid has a low viscosity. Such a low-viscosity first liquid produces toner particles having a narrow size distribution.

The second liquid is prepared by emulsifying the first liquid in an aqueous medium. The aqueous medium may be, for example, water or a mixture of water and a water-miscible solvent. Specific examples of usable water-miscible solvents include, but are not limited to, alcohols (e.g., methanol, isopropanol, ethylene glycol), dimethylformamide, tetrahydrofuran, cellosolves (e.g., methyl cellosolve), and lower ketones (e.g., acetone, methyl ethyl ketone).

The first liquid is dispersed in the aqueous medium using a low-speed shearing disperser, a high-speed shearing disperser, a frictional disperser, a high-pressure jet disperser, or an ultrasonic disperser, for example. Among these dispersers, the high-speed shearing disperser is preferable. When using the high-speed shearing disperser, the revolution is preferably from 1,000 to 30,000 rpm, and more preferably from 5,000 to 20,000 rpm. The dispersing time is preferably from 0.1 to 5 minutes.

The amount of the aqueous medium is preferably from 50 to 2,000 parts by weight, more preferably from 100 to 1,000 parts by weight, based on 100 parts by weight of solid components in the first liquid. When the amount of the aqueous medium is too small, the first liquid may not be finely dispersed therein, and therefore the resulting toner may not have a desired particle size. When the amount of the aqueous medium is too large, manufacturing cost may increase.

The aqueous medium may contain a dispersant, if needed. The dispersant narrows the size distribution of the resulting toner and stabilizes the second liquid. The dispersant may be, for example, a surfactant, an inorganic particle dispersant, or a resin particle dispersant.

Specific preferred examples of suitable dispersants include, but are not limited to, anionic surfactants (e.g., alkylbenzene sulfonates, α-olefin sulfonates, phosphates), amine-salt-type cationic surfactants (e.g., alkylamine salts, amino alcohol fatty acid derivatives, polyamine fatty acid derivatives, imidazoline), quaternary-ammonium-salt-type cationic surfactants (e.g., alkyl trimethyl ammonium salts, dialkyl dimethyl ammonium salts, alkyl dimethyl benzyl ammonium salts, pyridinium salts, alkyl isoquinolinium salts, benzethonium chloride), nonionic surfactants (e.g., fatty acid amide derivatives, polyvalent alcohol derivatives), and ampholytic surfactants (e.g., alanine, dodecyl di(aminoethyl)glycine, di(octylaminoethyl)glycine, N-alkyl-N,N-dimethylammonium betain). Surfactants having a fluoroalkyl group are also preferable. They are effective in small amounts.

Specific examples of anionic surfactants having a fluoroalkyl group include, but are not limited to, fluoroalkyl carboxylic acids having 2 to 10 carbon atoms and metal salts thereof, perfluorooctane sulfonyl glutamic acid disodium, 3-[ω-fluoroalkyl(C6-C11)oxy]-1-alkyl(C3-C4) sulfonic acid sodium, 3-[ω-fluoroalkanoyl(C6-C8)-N-ethylamino]-1-propane sulfonic acid sodium, fluoroalkyl(C11-C20)carboxylic acids and metal salts thereof, perfluoroalkyl(C7-C13)carboxylic acids and metal salts thereof, perfluoroalkyl(C4-C12)sulfonic acids and metal salts thereof, perfluorooctane sulfonic acid diethanol amide, N-propyl-N-(2-hydroxyethyl)perfluorooctane sulfonamide, perfluoroalkyl(C6-C10)sulfonamide propyl trimethyl ammonium salts, perfluoroalkyl(C6-C10)-N-ethyl sulfonyl glycine salts, and monoperfluoroalkyl(C6-C16)ethyl phosphates.

Specific examples of commercially available such anionic surfactants having a fluoroalkyl group include, but are not limited to, SURFLON® S-111, S-112, and S-113 (from AGC Seimi Chemical Co., Ltd.); FLUORAD™ FC-93, FC-95, FC-98, and FC-129 (from Sumitomo 3M); UNIDYNE™ DS-101 and DS-102 (from Daikin Industries, Ltd.); MEGAFACE F-110, F-120, F-113, F-191, F-812, and F-833 (from DIC Corporation); EFTOP EF-102, 103, 104, 105, 112, 123A, 123B, 306A, 501, 201, and 204 (from Mitsubishi Materials Electronic Chemicals Co., Ltd.); and FTERGENT F-100 and F-150 (from Neos Company Limited).

Specific examples of cationic surfactants having a fluoroalkyl group include, but are not limited to, aliphatic primary, secondary, and tertiary amine acids having a fluoroalkyl group; and aliphatic quaternary ammonium salts such as perfluoroalkyl(C6-C10)sulfonamide propyl trimethyl ammonium salts, benzalkonium salts, benzethonium chlorides, pyridinium salts, and imidazolinium salts.

Specific examples of commercially available such cationic surfactants having a fluoroalkyl group include, but are not limited to, SURFLON® S-121 (from AGC Seimi Chemical Co., Ltd.); FLUORAD™ FC-135 (from Sumitomo 3M); UNIDYNE™ DS-202 (from Daikin Industries, Ltd.); MEGAFACE F-150 and F-824 (from DIC Corporation); EFTOP EF-132 (from Mitsubishi Materials Electronic Chemicals Co., Ltd.); and FTERGENT F-300 (from Neos Company Limited).

Specific preferred materials suitable for the inorganic particle dispersant include, but are not limited to, tricalcium phosphate, calcium carbonate, titanium oxide, colloidal silica, and hydroxyapatite.

Specific preferred materials suitable for the resin particle dispersant include, but are not limited to, PMMA particles, polystyrene particles, and styrene-acrylonitrile copolymer particles.

Specific examples of commercially available such resin particle dispersant include, but are not limited to, PB-200H (from Kao Corporation), SGP and SGP-3G (from Soken Chemical & Engineering Co., Ltd.), TECHPOLYMER SB (from Sekisui Plastics Co., Ltd.), and MICROPEARL (from Sekisui Chemical Co., Ltd.).

Additionally, the inorganic or resin particle dispersant may be used in combination with a polymeric protection colloid. Specific examples of usable polymeric protection colloids include, but are not limited to, homopolymers and copolymers obtained from monomers, such as acid monomers (e.g., acrylic acid, methacrylic acid, α-cyanoacrylic acid, α-cyanomethacrylic acid, itaconic acid, crotonic acid, fumaric acid, maleic acid, maleic anhydride), acrylate and methacrylate monomers having a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylate, diethylene glycol monomethacrylate, glycerin monoacrylate, glycerin monomethacrylate, N-methylol acrylamide, N-methylol methacrylamide), vinyl alcohol monomers, vinyl alcohol ether monomers (e.g., vinyl methyl ether, vinyl ethyl ether, vinyl propyl ether), ester monomers of vinyl alcohols with carboxylic acids (e.g., vinyl acetate, vinyl propionate, vinyl butyrate), amide monomers (e.g., acrylamide, methacrylamide, diacetone acrylamide) and methylol compounds thereof, acid chloride monomers (e.g., acrylic acid chloride, methacrylic acid chloride) and/or monomers containing nitrogen atom or a nitrogen-containing heterocyclic ring (e.g., vinyl pyridine, vinyl pyrrolidone, vinyl imidazole, ethylene imine); polyoxyethylenes (e.g., polyoxyethylene, polyoxypropylene, polyoxyethylene alkyl amine, polyoxypropylene alkyl amine, polyoxyethylene alkyl amide, polyoxypropylene alkyl amide, polyoxyethylene nonyl phenyl ether, polyoxyethylene lauryl phenyl ether, polyoxyethylene stearyl phenyl ester, polyoxyethylene nonyl phenyl ester); and celluloses (e.g., methyl cellulose, hydroxyethyl cellulose, hydroxypropyl cellulose).

The toner is obtained by evaporating the organic solvent from the second liquid, followed by washing and drying.

The toner preferably has a volume average particle diameter of from 3 to 7 μm. When a toner having a volume average particle diameter less than 3.0 μm is used for a one-component developer, toner particles may form a film on a developing roller or adhere to a toner regulator. When such a toner is used for a two-component developer, toner particles may adhere to the surfaces of carrier particles when agitated in a developing device, resulting in deterioration of charging ability of the carrier particles. On the other hand, a toner having a volume average particle diameter greater than 7 μm is difficult to produce high-resolution and high-quality images. When such a toner is used for a two-component developer, the average particle diameter of toner particles in the developer may vary along with repeated consumption and supplement of toner particles.

Additionally, the ratio of the volume average particle diameter to the number average particle diameter is preferably from 1.0 to 1.2. When the ratio is too large, each toner particle may behave differently when developing an electrostatic latent image, resulting in a toner image with low micro-dot reproducibility.

The volume and number average particle diameters can be measured by a Coulter Counter.

Preferably, the toner includes particles having a particle diameter of 2 μm or less in an amount of 10% by number or less. When such a toner including particles having a particle diameter of 2 μm or less in an amount greater than 10% by number is used for a two-component developer, toner particles may adhere to the surfaces of carrier particles when agitated in a developing device, resulting in deterioration of charging ability of the carrier particles.

The toner preferably has an average circularity of from 0.94 to 0.99. When the average circularity is too small, it means that most of the toner particles have an irregular shape far from a sphere. Such a toner may not be effectively transferred from a photoreceptor onto a transfer material. When the average circularity is too large, such a toner is difficult to remove from a photoreceptor or a transfer belt, contaminating the resultant image.

Both the content of particles having a particle diameter of 2 μm or less and the average circularity can be measured by a flow particle image analyzer.

The toner preferably has a shape factor SF-1 of from 110 to 200, more preferably from 120 to 180. When SF-1 is too small, such a toner is difficult to remove with a blade member. When SF-1 is too large, each toner particle does not migrate smoothly and behaves differently when transferred onto a transfer medium. Moreover, the charge of such a toner is unstable. Further, such toner particles may be finely pulverized to deteriorate durability of a developer because of being too brittle.

The toner preferably has a shape factor SF-2 of from 110 to 300. When SF-2 is too small, such a toner is difficult to remove from a photoreceptor or a transfer belt. When SF-2 it too large, such a toner cannot be effectively transferred onto a transfer medium.

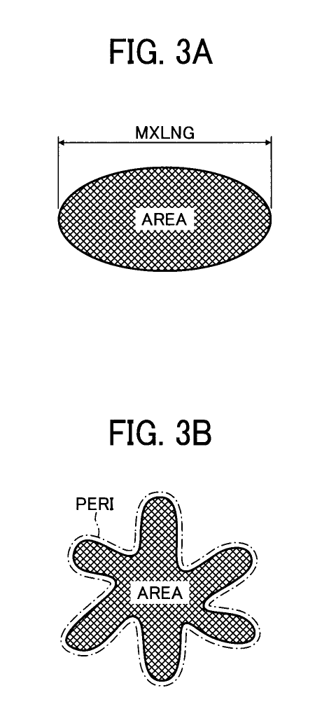

FIGS. 3A and 3B are schematic views for explaining the shape factors SF-1 and SF-2, respectively.

As illustrated in FIG. 3A, the shape factor SF-1 represents the degree of roundness of a toner particle, and is defined by the following equation (1):

SF-1={(MXLNG)²/(AREA)}×(100π/4) (1)

wherein MXLNG represents the maximum diameter of a projected image of a toner particle to a two-dimensional plane; and AREA represents the area of the projected image.

As illustrated in FIG. 3B, the shape factor SF-2 represents the degree of roughness of a toner particle, and is defined by the following equation (2):

SF-2={(PERI)²/(AREA)}×(100/4π) (2)

wherein PERI represents the peripheral length of a projected image of a toner particle to a two-dimensional plane; and AREA represents the area of the projected image.

When the SF-1 is 100, the toner particle has a true spherical shape. The larger SF-1 a toner particle has, the more irregular shape the toner particle has.

When the SF-2 is 100, the toner particle has no concavity and convexity, i.e., a smooth surface. The larger SF-2 a toner particle has, the rougher surface the toner particle has.

Generally, a full-color copier develops more toner on a photoreceptor compared to a monochrome copier. Therefore, in full-color copiers, it is difficult to increase transfer efficiency only by using irregular-shaped toner particles. Additionally, irregular-shaped toner particles are likely to adhere to the surfaces of a photoreceptor and/or an intermediate transfer member, because shear force and/or frictional force generate between the photoreceptor and a cleaning member, between the intermediate transfer member and a cleaning member, and/or between the photoreceptor and the intermediate transfer member, resulting in low transfer efficiency. In such a case, toner images of cyan, magenta, yellow, and black each are transferred nonuniformly. When using an intermediate transfer member, the resulting toner image may have color unevenness. A toner manufactured through the method according to this specification solves the above-described problems.

The toner preferably has a glass transition temperature of from 40 to 70° C. When the glass transition temperature is too low, the toner may cause blocking in a developing device or may form a film on a photoreceptor. When the glass transition temperature is too high, the resulting toner may have poor low-temperature fixability.

A charge controlling agent may be fixed on the surface of the toner by, for example, mixing the toner and the charge controlling agent in a container using a rotator. More specifically, the toner and the charge controlling agent may be mixed in a container having no projection on the inner wall surface using a rotator at a peripheral speed of from 40 to 150 m/sec.

Specific preferred examples of suitable charge controlling agent include, but are not limited to, nigrosine dyes, triphenylmethane dyes, chrome-containing metal complex dyes, molybdenum acid chelate pigments, rhodamine dyes, alkoxy amines, quaternary ammonium salts, alkylamides, phosphor and phosphor-containing compounds, tungsten and tungsten-containing compounds, fluorine-containing surfactants, metal salts of salicylic acid, metal salts of salicylic acid derivatives, copper phthalocyanine, perylene, quinacridone, azo pigments, and polymers having a functional group such as a sulfonic group, a carboxyl group, and a quaternary ammonium salt group.

Specific examples of commercially available charge controlling agents include, but are not limited to, BONTRON® N-03 (nigrosine dye), BONTRON® P-51 (quaternary ammonium salt), BONTRON® S-34 (metal-containing azo dye), BONTRON® E-82 (metal complex of oxynaphthoic acid), BONTRON® E-84 (metal complex of salicylic acid), and BONTRON® E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE® PSY VP2038 (quaternary ammonium salt), COPY BLUE® PR (triphenylmethane derivative), COPY CHARGE® NEG VP2036 and COPY CHARGE® NX VP434 (quaternary ammonium salts), which are manufactured by Hoechst AG; LRA-901, and LR-147 (boron complex), which are manufactured by Japan Carlit Co., Ltd.

The content of the charge controlling agent in the toner is preferably from 0.1 to 10 parts by weight, more preferably from 0.2 to 5 parts by weight, based on 100 parts by weight of the binder resin. When the content of the charge controlling agent is too large, the resulting toner may generate too large an electrostatic attractive force between a developing roller, resulting in deterioration of fluidity of the toner and/or image density.

The charge controlling agent may be added as a resin master batch or directly added to the first liquid.

Inorganic particles may be further adhered to the surface of the toner to improve fluidity, developability, and chargeability.

Specific preferred examples of suitable inorganic particles include, but are not limited to, silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, and silicon nitride. Two or more of these materials can be used in combination. In particular, a mixture of hydrophobized silica particles and hydrophobized titanium oxide particles is preferable, and more preferably, the average particle diameter of the hydrophobized silica particles and hydrophobized titanium oxide particles is 50 nm or less. Such inorganic particles are unlikely to release from the toner particles even when agitated in a developing device.

The inorganic particles preferably have an average primary particle diameter of from 5 nm to 2 μm, and more preferably from 5 to 500 nm. The inorganic particles preferably have a BET specific surface area of from 20 to 500 m²/g.

The content of the inorganic particles in the toner is preferably from 0.01 to 5% by weight, and more preferably from 0.01 to 2.0% by weight.

The toner manufactured by the method according to this specification can be mixed with a magnetic carrier to be used as a two-component developer. The amount of the toner in the two-component developer is preferably from 1 to 10 parts by weight based on 100 parts by weight of the magnetic carrier.

The magnetic carrier may be, for example, powders of iron, ferrite, or magnetite, having a particle diameter of about 20 to 200 μm.

The magnetic carrier may have a covering layer comprising a resin on its surface. Specific preferred examples of suitable resins include, but are not limited to, amino resins (e.g., urea-formaldehyde resins, melamine resins, benzoguanamine resins, urea resins, polyamide resins, epoxy resins), polyvinyl and polyvinylidene resins (e.g., acrylic resins, polymethyl methacrylate, polyacrylonitrile, polyvinyl acetate, polyvinyl alcohol, polyvinyl butyral), polystyrene resins (e.g., polystyrene, styrene-acrylic copolymer resins), halogenated olefin resins (e.g., polyvinyl chloride), polyethylene, polyvinyl fluoride, polyvinylidene fluoride, polytrifluoroethylene, polyhexafluoropropylene, vinylidene fluoride-acrylic copolymer, vinylidene fluoride-vinyl fluoride copolymer, fluoroterpolymers such as tetrafluoroethylene-vinylidene fluoride-nonfluorinated monomer terpolymer), polyesters (e.g., polyethylene terephthalate, polybutylene terephthalate), polycarbonates, and silicone resins.

The covering layer may further include conductive powders. Specific examples of usable conductive powders include, but are not limited to, metal powders, carbon black, titanium oxide, tin oxide, and zinc oxide.

The conductive powders preferably have an average particle diameter of 1 μm or less. When the average particle diameter is too large, it is difficult to control electrical resistance of the covering layer.

Alternatively, the toner manufactured by the method according to this specification can be used as a one-component developer without mixed with a magnetic carrier.

Such one-component or two-component developers comprising the toner manufactured by the method according to this specification can be used for image forming apparatuses.

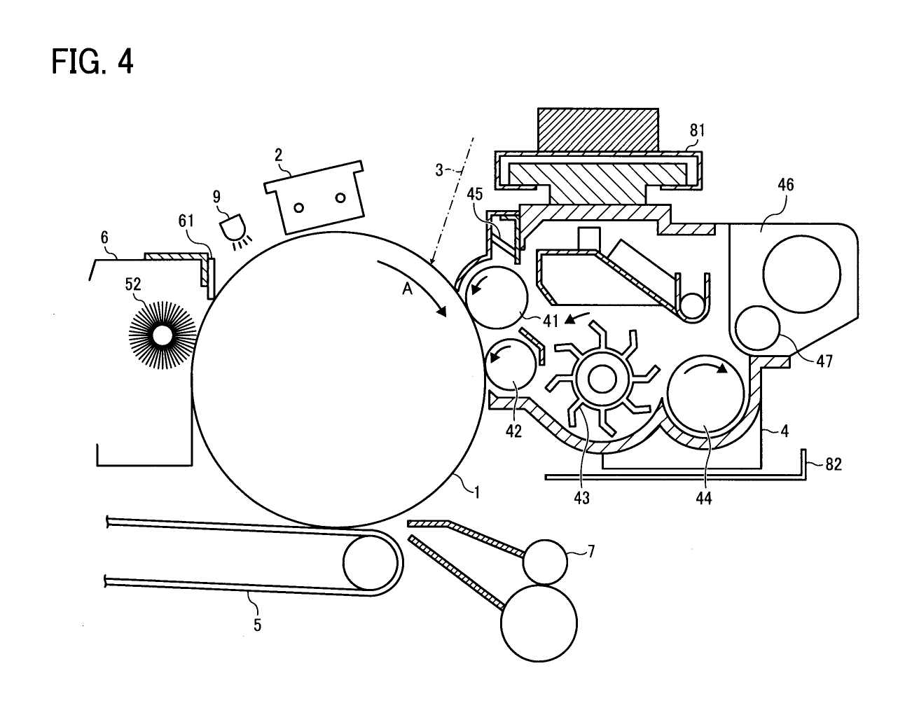

FIG. 4 schematically illustrates an electrophotographic image forming apparatus to which the toner manufactured by the method according to this specification is applicable.

In the image forming apparatus, a photoreceptor 1 rotates in a direction indicated by arrow A in FIG. 4. The photoreceptor 1 is charged by a charger 2 and then exposed to a laser light beam 3 containing image information. Around the photoreceptor 1, a developing device 4, a transfer device 5, a cleaning device 6, a neutralization lamp 9, and a paper feeder 7 are provided. The developing device 4 includes developing rollers 41 and 42, an agitation paddle 43, an agitation member 44, a doctor 45, a toner supply part 46, a supply roller 47. The cleaning device 6 includes a cleaning blade 61 and a cleaning brush 52. Guide rails 81 and 82 are provided above and below the developing device 4 for attaching/detaching and supporting the developing device 4.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

### Preparation of Particulate Resin Dispersion

A reaction vessel equipped with a stirrer and a thermometer was charged with 683 parts of water, 11 parts of a sodium salt of a sulfate of ethylene oxide adduct of methacrylic acid (ELEMINOL RS-30 from Sanyo Chemical Industries, Ltd.), 83 parts of styrene, 83 parts of methacrylic acid, 110 parts of butyl acrylate, and 1 part of ammonium persulfate. The mixture was agitated for 15 minutes at a revolution of 450 rpm, thus preparing a whitish emulsion. The emulsion was then heated to 75° C. and subjected to reaction for 5 hours. Thereafter, 30 parts of a 1% aqueous solution of ammonium persulfate were added thereto, and the resulting mixture was aged for 5 hours at 75° C. Thus, an aqueous dispersion of a vinyl resin (i.e., a copolymer of styrene, methacrylic acid, butyl acrylate, and a sodium salt of a sulfate of ethylene oxide adduct of methacrylic acid) was prepared. This dispersion is hereinafter called as the particulate resin dispersion 1.

Resin particles in the particulate resin dispersion 1 had a volume average particle diameter of 105 nm measured by a laser diffraction particle size distribution analyzer LA-920 (from Horiba, Ltd.), a glass transition temperature of 59° C., and a weight average molecular weight of 150,000.

### Preparation of Polyester

A reaction vessel equipped with a condenser, a stirrer, and a nitrogen inlet pipe was charged with 229 parts of ethylene oxide 2 mol adduct of bisphenol A, 529 parts of propylene oxide 3 mol adduct of bisphenol A, 208 parts of terephthalic acid, 46 parts of isophthalic acid, and 2 parts of dibutyl tin oxide. The mixture was subjected to reaction for 5 hours at 230° C. under normal pressures, and subsequently for 5 hours under reduced pressures of from 10 to 15 mmHg. Thereafter, 44 parts of trimellitic anhydride were added thereto and the mixture was further subjected to reaction for 2 hours at 180° C. under normal pressures. Thus, a polyester 1 was prepared.

The polyester 1 had a glass transition temperature of 45° C. and an acid value of 20 mgKOH/g. THF-soluble components in the polyester 1 had a weight average molecular weight of 5,200.

### Preparation of Prepolymer

A reaction vessel equipped with a condenser, a stirrer, and a nitrogen inlet pipe was charged with 795 parts of ethylene oxide 2 mol adduct of bisphenol A, 200 parts of isophthalic acid, 65 parts of terephthalic acid, and 2 parts of dibutyl tin oxide. The mixture was subjected to reaction for 8 hours at 210° C. under nitrogen gas flow at normal pressures, subsequently for 5 hours under reduced pressures of from 10 to 15 mmHg while removing the produced water, and cooled to 80° C. After adding 1,300 parts of ethyl acetate and 170 parts of isophorone diisocyanate, the mixture was further subjected to reaction for 2 hours. Thus, a prepolymer 1 was prepared.

The prepolymer 1 had a weight average molecular weight of 5,000.

### Preparation of Master Batch

First, 1,200 parts of water, 174 parts of a quaternary-ammonium-ion-exchanged modified bentonite BENTONE® 57 (from Elementis Specialities), and 1,570 parts of the polyester 1 were mixed using a HENSCHEL MIXER (from Mitsui Mining and Smelting Co., Ltd.). The resulting mixture was kneaded for 30 minutes at 150° C. using a double roll kneader, the kneaded mixture was then rolled and cooled, and the rolled mixture was then pulverized into particles using a pulverizer (from Hosokawa Micron Corporation). Thus, a master batch 1 was prepared.

The modified bentonite had a volume average particle diameter of 0.4 μm in the master batch. The master batch included the modified bentonite particles having a particle diameter of 1 μm or more in an amount of 2% by volume.

### Preparation of First Liquid 1

In a vessel, 23.4 parts of the prepolymer 1, 123.6 parts of the polyester 1, 20 parts of the master batch 1, and 80 parts of ethyl acetate were mixed. In another vessel, 15 parts of a carnauba wax, 20 parts of a carbon black, and 120 parts of ethyl acetate were mixed for 30 minutes using a bead mill. The resulting two liquids were mixed using a TK HOMOMIXER for 5 minutes at a revolution of 12,000 rpm, and subsequently subjected to dispersion for 10 minutes using a bead mill. The resulting dispersion is further mixed with 2.9 parts of isophoronediamine using a TK HOMOMIXER for 5 minutes at a revolution of 12,000 rpm. Thus, a first liquid 1 is prepared.

### Preparation of First Liquid 2

In a vessel, 23.4 parts of the prepolymer 1, 141.6 parts of the polyester 1, 7 parts of an organo-silica zol MEK-ST (from Nissan Chemical Industries, Ltd.) including 30% by weight of solid components having an average primary particle diameter of 15 nm, and 64 parts of ethyl acetate were mixed. In another vessel, 15 parts of a carnauba wax, 20 parts of a carbon black, and 120 parts of ethyl acetate were mixed for 30 minutes using a bead mill. The resulting two liquids were mixed using a TK HOMOMIXER for 5 minutes at a revolution of 12,000 rpm, and subsequently subjected to dispersion for 10 minutes using a bead mill. The resulting dispersion is further mixed with 2.9 parts of isophoronediamine using a TK HOMOMIXER for 5 minutes at a revolution of 12,000 rpm. Thus, a first liquid 2 is prepared.

### Preparation of Aqueous Medium

An aqueous medium was prepared by mixing and agitating 529.5 parts of ion-exchange water, 70 parts of the particulate resin dispersion 1, and 0.5 parts of sodium dodecylbenzenesulfonate, using a TK HOMOMIXER at a revolution of 12,000 rpm. Thus, an aqueous medium 1 was prepared.

### Preparation of Second Liquid

First, 36 kg of the aqueous medium 1 and 24 kg of the first liquid 1 were agitated for 30 minutes, thus preparing 60 kg of an emulsion, i.e., a second liquid. The second liquid had a viscosity of 500 mPa·sec when measured with a Brookfield viscometer at a revolution of 60 rpm and a temperature of 25° C. The second liquid included 20% by weight of ethyl acetate and 22% by weight of solid components.

### Evaporation of Organic Solvents

The organic solvents were evaporated from the second liquid using the solvent removing apparatus 100 illustrated in FIG. 1 under the following conditions.

The temperature of the inner wall surface of the inner pipe 13 was set to 60° C. The inner pressure of the inner pipe 13 was set to 75 mmHg (10 kPa). The second liquid in an amount of 50 kg was supplied to the apparatus 100 at a supply temperature of 18° C. and a supply flow rate of 100 kg/h. The second liquid thus supplied was formed into a liquid film and heated at not higher than the glass transition temperature of the binder resin by contact with the inner wall surface of the inner pipe 13 so that the ethyl acetate was evaporated from the second liquid. The heat insulating part 3 was formed of a TEFLON® plate having a thickness of 10 mm sandwiched by flanges fixed with resin bolts. The outer temperature of the supply part 2 was set at not higher than 25° C.

The inner pipe 13 had a heat transfer area S of 0.27 m² and a length of 3 m. The diameter and peripheral length L of the heat transfer area were 28.4 mm and 89.2 mm, respectively. It took 30 minutes for supplying the 50 kg of the second liquid to the apparatus 100, in other words, for evaporating the ethyl acetate from the 50 kg of the second liquid. The discharged second liquid from which the ethyl acetate was removed (hereinafter the “slurry”) had a weight of about 45 kg and includes 5.3% by weight of residual ethyl acetate and 28.6% by weight of solid components. The slurry had a temperature not higher than 40° C.

The slurry was contained in a tank equipped with a jacket and aged while setting the water temperature of the jacket to 45° C., followed by filtration, washing, drying, and wind power classification. Thus, spherical mother toner particles were obtained.

Next, 100 parts of the mother toner particles and 0.25 parts of a charge controlling agent BONTRON® (from Orient Chemical Industries Co., Ltd.) were mixed using a Q-type MIXER (from Mitsui Mining and Smelting Co., Ltd.) equipped with turbine type blades, by operating the Q-type MIXER for 2 minutes at a peripheral speed of 50 m/sec, followed by pause for 1 minute. This operation was repeated for 5 times. Further, 0.5 parts of a hydrophobized silica H2000 (from Clariant Japan K.K.) were mixed therein by operating the Q-type MIXER for 30 seconds at a peripheral speed of 15 m/sec, followed by pause for 1 minute. This operation was repeated for 5 times. Thus, a toner 1 is prepared.

### Example 2

The procedure in Example 1 was repeated except that a hose flowing cooling water was wound around the outer surface of the supply part 2 so that the outer temperature was kept at 20° C.

More specifically, the organic solvents were evaporated from the second liquid using the solvent removing apparatus 100 illustrated in FIG. 1 under the following conditions.

The temperature of the inner wall surface of the inner pipe 13 was set to 60° C. The inner pressure of the inner pipe 13 was set to 75 mmHg (10 kPa). The second liquid in an amount of 50 kg was supplied to the apparatus 100 at a supply temperature of 18° C. and a supply flow rate of 100 kg/h. The second liquid thus supplied was formed into a liquid film and heated at not higher than the glass transition temperature of the binder resin by contact with the inner wall surface of the inner pipe 13 so that the ethyl acetate was evaporated from the second liquid. The heat insulating part 3 was formed of a TEFLON® plate having a thickness of 10 mm sandwiched by flanges fixed with resin bolts. Further, a hose flowing cooling water is wound around the outer surface of the supply part 2 so that the outer temperature is kept at 20° C.

The inner pipe 13 had a heat transfer area S of 0.27 m² and a length of 3 m. The diameter and peripheral length L of the heat transfer area were 28.4 mm and 89.2 mm, respectively. It took 30 minutes for supplying the 50 kg of the second liquid to the apparatus 100, in other words, for evaporating the ethyl acetate from the 50 kg of the second liquid. The discharged second liquid from which the ethyl acetate was removed (hereinafter the “slurry”) had a weight of about 40 kg and includes 3.7% by weight of residual ethyl acetate and 29.9% by weight of solid components. The slurry had a temperature not higher than 40° C.

### Comparative Example 1

The procedure in Example 1 was repeated except that the heat insulating part 3 was removed and the flanges were fixed with SUS bolts. It took 30 minutes for evaporating the ethyl acetate from the 50 kg of the second liquid. The discharged second liquid from which the ethyl acetate was removed (hereinafter the “slurry”) had a weight of about 41 kg and includes 6.6% by weight of residual ethyl acetate and 27.6% by weight of solid components. The bottom surface of the supply part 2 was burnt due to toner accumulation. The outer temperature of the supply part 2 was above 56° C.

The conditions in Examples and Comparative Examples are summarized in Table 1.

TABLE 1

| | | | Comparative |
|---|---|---|---|
| | Example 1 | Example 2 | Example 1 |
| Viscosity (mPa · sec) of Second Liquid | 500 | 500 | 500 |
| Degree of Vacuum | 75 mmHg | 75 mmHg | 75 mmHg |
| | (10 kPa) | (10 kPa) | (10 kPa) |
| Glass Transition Temperature (° C.) of | 54.2 | 54.1 | 53.8 |
| Binder Resin | | | |
| Temperature T2 (° C.) at Supply Part | 20 | 20 | 20 |
| Supply Temperature T1 (° C.) | 18 | 18 | 18 |
| Outer Temperature (° C.) of Supply Part | 25 | 20 | 56 |
| Temperature X (° C.) of Slurry | 18 << X ≦ 40 | 18 << X ≦ 40 | 18 << X ≦ 40 |
| Average Size Φ_{V} (μm) of Modified | 0.4 | 0.4 | 0.4 |
| Inorganic Mineral | | | |
| Content (% by volume) of Coarse | 2 | 2 | 2 |
| particles with Φ_{V} ≧ 1 μm | | | |
| Heat Transfer Area (m²) of Inner Pipe | 0.27 | 0.27 | 0.27 |
| Length (m) of Inner Pipe | 3 | 3 | 3 |
| Peripheral Length (mm) of Inner Pipe | 28.4 | 28.4 | 28.4 |
| Supply Flow Rate (kg/h) | 100 | 100 | 100 |
| Content (% by weight) of Ethyl Acetate | 20 | 20 | 20 |
| in Second Liquid | | | |
| Content (% by weight) of Solid | 22 | 22 | 22 |
| Components in Second Liquid | | | |
| Time (min) of Evaporating Ethyl Acetate | 30 | 30 | 30 |
| Content (% by weight) of Residual Ethyl | 5.3 | 3.7 | 6.6 |
| Acetate in Slurry | | | |
| Burning at Bottom of Supply Part | Not | Not | Observed |
| | observed | observed | |

Each of the toners prepared in Examples 1 and 2 and Comparative Example 1 was subjected to measurements of volume and number average particle diameters (Dv and Dn), the ratio Dv/Dn, the content of toner particles having a diameter of 2 μm or less, average circularity, and the shape factors SF-1 and SF-2. The results are shown in Table 2.

TABLE 2

| | | | | Comparative |
|---|---|---|---|---|
| | | Example 1 | Example 2 | Example 1 |
| Particle | Dv (μm) | 5.3 | 5.1 | 6.2 |
| Diameter & | Dv/Dn | 1.13 | 1.12 | 1.24 |
| Particle | Content | 3.8 | 2.1 | 12.2 |
| Shape | (% by number) | | | |
| | of Particles ≦2 μm | | | |
| | Average Circularity | 0.95 | 0.96 | 0.94 |
| | SF-1 | 128 | 138 | 151 |
| | SF-2 | 132 | 133 | 139 |

| | | | |
|---|---|---|---|
| Glass Transition Temperature | 54.2 | 54.1 | 53.8 |
| (° C.) | | | |

Each of the toners prepared in Examples 1 and 2 and Comparative Example 1 was further subjected to various evaluations. The evaluation results are shown in Table 3.

TABLE 3

| | | | | Comparative |
|---|---|---|---|---|
| | | Example 1 | Example 2 | Example 1 |
| Image Density | | A | A | B |
| Image Granularity & Sharpness | | B | B | C |
| Background Fouling | | B | B | D |
| Toner Scattering | | A | A | B |
| Cleanability | | A | A | A |
| Charge Stability | HH condition | B | B | B |
| | LL condition | B | B | B |
| Fixability | Minimum | A | A | C |
| | Fixable | | | |
| | Temperature | | | |
| | Maximum | A | A | C |
| | Fixable | | | |
| | Temperature | | | |

| | | | |
|---|---|---|---|
| Heat-resistant Storage Stability | B | B | B |

Procedures in the above measurements and evaluations are described in detail below.

### Measurement of Number and Weight Average Molecular Weight

The number and weight average molecular weights were measured by gel permeation chromatography (GPC) as follows. First, columns in which tetrahydrofuran was flowing at a flow rate of 1 ml/min was stabilized in a heat chamber at 40° C. Next, 50 to 200 μl of a tetrahydrofuran solution containing 0.05 to 0.6% by weight of a sample were injected into the columns. The number and weight average molecular weights were calculated from number of counts detected by a refractive index detector with reference to a calibration curve compiled from multiple polystyrene standard samples. The multiple polystyrene standard samples include monodisperse polystyrene samples each having a molecular weight of 6×10², 2.1×10³, 4×10³, 1.75×10⁴, 5.1×10⁴, 1.1×10⁵, 3.9×10⁵, 8.6×10⁵, 2×10⁶, and 4.48×10⁶ (obtainable from Pressure Chemical Company or Tosoh Corporation).

### Measurement of Particle Size of Modified Inorganic Mineral in Master Batch

A master batch including a resin and a modified inorganic mineral and another amount of the resin used for the master batch were added to ethyl acetate dissolving 5% by weight of a dispersant DISPER BYK-167 (from BYK Chemie) so that the weight ratio of the modified inorganic mineral to the total resin becomes 0.1. The mixture was agitated for 12 hours. The master batch and the resin occupied 5% by weight of the total amount of the mixture.

The mixture (i.e., a sample) was subjected to a measurement using a Laser Doppler Particle Size Analyzer NANOTRAC UPA-150EX (from Nikkiso Co., Ltd.) under the following conditions.

Displayed distribution: By volume

Number of channels: 52

Measuring time: 15 seconds

Refractive index of particles: 1.54

Temperature: 25° C.

Particle size: Non-sphere

Viscosity (CP): 0.441

Refractive index of solvent: 1.37

Solvent: Ethyl acetate

The sample was loaded while being diluted with ethyl acetate using a dropper or an injector so that a Sample Loading Indicator indicates 1-100.

### Measurement of Acid Value

Acid value was measured based on a method according to JIS K0070-1992 as follows. First, 0.5 g of a sample was added to 120 ml of toluene, and the mixture was agitated for about 10 hours at room temperature (23° C.) so that the sample dissolved in the toluene. When the sample did not dissolve in the toluene, dioxane or tetrahydrofuran was used in place of toluene. Further, 30 ml of ethanol were added thereto.

The resulting liquid was subjected to a measurement using an automatic potentiometric titrator DL-53 TITRATOR (from Mettler-Toledo International Inc.) along with electrodes DG113-SC (from Mettler-Toledo International Inc.) and an analysis software program LabX Light Version 1.00.000 at 23° C. The potentiometric titrator was calibrated using a mixed solvent of 120 ml of toluene and 30 ml of ethanol. The measurement settings were as follows.

| | |
|---|---|
| Stir | |
| Speed [%] | 25 |
| Time [s] | 15 |
| EQP titration | |
| Titrant/Sensor | |
| Titrant | CH₃ONa |
| Concentration [mol/L] | 0.1 |
| Sensor | DG115 |
| Unit of measurement | mV |
| Predispensing to volume | |
| Volume [mL] | 1.0 |
| Wait time [s] | 0 |
| Titrant addition Dynamic | |
| dE(set) [mV] | 8.0 |
| dV(min) [mL] | 0.03 |
| dV(max) [mL] | 0.5 |
| Measure mode Equilibrium controlled | |
| dE [mV] | 0.5 |
| dt [s] | 1.0 |
| t(min) [s] | 2.0 |
| t(max) [s] | 20.0 |
| Recognition | |
| Threshold | 100.0 |
| Steepest jump only | No |
| Range | No |
| Tendency | None |
| Termination | |
| at maximum volume [mL] | 10.0 |
| at potential | No |
| at slope | No |
| after number EQPs | Yes |
| n = 1 | |
| comb. termination condition | No |
| Evaluation | |
| Procedure | Standard |
| Potential 1 | No |
| Potential 2 | No |
| Stop for reevaluation | No |

### Measurement of Residual Ethyl Acetate in Slurry

First, 4 g of toluene were weighed in a measuring flask and diluted with 500 mL of DMF to prepare an internal standard solution. Next, 1.5 g of a slurry were diluted with about 50 mL of DMF, and 10 mL of the internal standard solution were added thereto using a pipette. The resulting diluted slurry was agitated by a stirrer for 4 minutes at a revolution of 400 rpm. Subsequently, the diluted slurry was set to an automatic sampler of a gas chromatograph GC-2010 (from Shimadzu Corporation) and subjected to a measurement. The residual amount of ethyl acetate in the slurry was calculated from the ratio between toluene and ethyl acetate by an internal standard method. The injection amount of the diluted slurry was 2.0 μL. The measurement conditions were as follows.

Sample Vaporizing Chamber
Injection mode: Split
Vaporizing chamber temperature: 180° C.
Carrier gas: He
Pressure: 40.2 kPa
Total flow: 56.0 mL/min
Column flow: 1.04 mL/min
Linear speed: 20.0 cm/sec
Purge flow: 3.0 mL/min
Split ratio: 50.0

Column
Name: ZB-50
Thickness of liquid phase: 0.25 μm
Length: 30.0 m
Inner diameter: 0.32 mmID
Maximum temperature: 340° C.

Column Oven
Column temperature: 60° C.
Temperature program: holding 60° C. for 6 minutes→heating at a rate 60° C./min→holding 230° C. for 5 minutes

Detector
Detector temperature: 250° C.
Makeup gas: N₂/Air
Makeup flow rate: 30.0 mL/min
N₂ flow rate: 47.0 mL/min
Air flow rate: 400 mL/min

### Measurement of Glass Transition Temperature

Glass transition temperature was measured with an instrument RIGAKU THERMOFLEX TG8110 (from Rigaku Corporation) at a heating rate of 10° C./min. An aluminum sampler containing about 10 mg of a sample was put on a holder unit and set in an electric furnace. The sample was heated from room temperature to 150° C. at a heating rate of 10° C./min, maintained at 150° C. for 10 minutes, cooled to room temperature, and left for 10 minutes. Subsequently, the sample was subjected to a DSC measurement by being reheated to 150° C. at a heating rate of 10° C./min in nitrogen atmosphere. The glass transition temperature was determined from an intersection of the tangent line and the base line of the resulting endothermic curve, using an analysis system of a TG-DSC system TAS-100 (from Rigaku Corporation).

### Measurement of Number Average Particle Diameter (Dn) and Volume Average Particle Diameter (Dv)

Number average particle diameter (Dn) and volume average particle diameter (Dv) were measured with an instrument COULTER COUNTER TA-II (from Beckman Coulter, Inc.) connected to an interface (from The Institute of Japanese Union of Scientists & Engineers) and a personal computer PC9801 (from NEC Corporation) for calculating number and volume particle size distribution, as follows.

First, 0.1 to 5 ml of a surfactant (an alkylbenzene sulfonate NEOGEN SC-A from Dai-ichi Kogyo Seiyaku Co., Ltd.) were included in 100 to 150 ml of an electrolyte (ISOTON-II from Coulter Electrons Inc.). Thereafter, 2 to 20 mg of a sample were added to the electrolyte and dispersed using an ultrasonic dispersing machine for about 1 to 3 minutes to prepare a toner suspension liquid. The weight and number of toner particles in the toner suspension liquid were measured by the above instrument equipped with an aperture of 100 μm.

The channels include 13 channels as follows: from 2.00 to less than 2.52 μm; from 2.52 to less than 3.17 μm; from 3.17 to less than 4.00 μm; from 4.00 to less than 5.04 μm; from 5.04 to less than 6.35 μm; from 6.35 to less than 8.00 μm; from 8.00 to less than 10.08 μm; from 10.08 to less than 12.70 μm; from 12.70 to less than 16.00 μm; from 16.00 to less than 20.20 μm; from 20.20 to less than 25.40 μm; from 25.40 to less than 32.00 μm; and from 32.00 to less than 40.30 μm. Accordingly, particles having a particle diameter of from not less than 2.00 μm to less than 40.30 μm were measured.

### Measurement of Average Circularity and Content of Particles Having a Particle Diameter of 2 μm or Less

Average circularity and the content of particles having a particle diameter of 2 μm or less were measured with a flow particle image analyzer FPIA-2100 and an analysis software program FPIA-2100 Data Processing Program for FPIA version 00-10 (from Sysmex Corporation). First, 0.1 to 0.5 ml of a 10% surfactant (an alkylbenzene sulfonate NEOGEN SC-A from Dai-ichi Kogyo Seiyaku Co., Ltd.) and 0.1 to 0.5 g of a sample were contained in a 100-ml glass beaker and mixed with a micro spatula, and 80 ml of ion-exchange water were further mixed therein. The resulting dispersion was dispersed using an ultrasonic dispersing machine (from Honda Electronics Co., Ltd.) for 3 minutes. Measurements of average circularity and the content of particles having a particle diameter of 2 μm or less were performed when the dispersion included 5,000 to 15,000 particles per micro liter.

### Measurement of Shape Factors SF-1 and SF-2

A toner was observed and photographed using a field emission scanning electron microscope (FE-SEM S-4200 from Hitachi, Ltd.). Randomly-selected 300 toner particles in the SEM image were analyzed with an image analyzer LUZEX AP (from Nireco Corporation) through an interface to calculate SF-1 and SF-2.

### Evaluation of Image Density

A toner was set in a digital full-color copier IMAGIO COLOR 2800 (from Ricoh Co., Ltd.), and a monochrome image having an image area of 50% was continuously printed on 150,000 sheets of paper. Thereafter, a solid image was printed on a paper TYPE 6000 (from Ricoh Co., Ltd.), and the image density of the solid image was measured with an instrument X-Rite (from X-Rite). In Table 3, the evaluation results were graded as follows.

Rank A: Not less than 1.8 and less than 2.2.

Rank B: Not less than 1.4 and less than 1.8.

Rank C: Not less than 1.2 and less than 1.4.

Rank D: Less than 1.2.

### Evaluation of Image Granularity and Sharpness

A toner was set in a digital full-color copier IMAGIO COLOR 2800 (from Ricoh Co., Ltd.), and a monochrome photographic image was produced. The image was visually observed to evaluate image granularity and sharpness. In Table 3, the evaluation results were graded as follows.

Rank A: Similar to offset printing quality.

Rank B: Slightly inferior to offset printing quality.

Rank C: Considerably inferior to offset printing quality.

Rank D: Similar to conventional electrophotographic image quality.

### Evaluation of Background Fouling

A toner was set in a digital full-color copier IMAGIO COLOR 2800 (from Ricoh Co., Ltd.), and a monochrome image having an image area of 50% was continuously printed on 30,000 sheets of paper. Thereafter, the copier stopped operation while producing a white solid image, and toner particles remaining on the photoreceptor were transferred onto a tape. The tape having the toner particles and a blank tape were subjected to measurement of image density using a 938 spectrodensitometer (from X-Rite). Background fouling was evaluated by the difference in image density therebetween and graded into four ranks, A (best), B, C, and D (worse).

### Evaluation of Toner Scattering

A toner was set in a digital full-color copier IMAGIO COLOR 2800 (from Ricoh Co., Ltd.), and a monochrome image having an image area of 50% was continuously printed on 50,000 sheets of paper. The inside of the copier was visually observed to evaluate the degree of toner scattering (toner contamination). In Table 3, the evaluation results were graded as follows.

Rank A: No problem.

Rank B: Toner scattered slightly, but no problem in practical use.

Rank C: Toner scattered considerably. Not suitable for practical use.

### Evaluation of Cleanability

Residual toner particles remaining on a photoreceptor after cleaning the photoreceptor were transferred onto a white paper by a SCOTCH® TAPE (from 3M). The white paper having the toner particles thereon and a blank white paper were subjected to measurement of reflected density using a Macbeth reflective densitometer RD514. In Table 3, cleanability was evaluated by the difference in reflected density therebetween and graded into the following two ranks.

Rank A: The difference is less than 0.01.

Rank B: The difference is not less than 0.01.

### Evaluation of Charge Stability

A toner was set in a digital full-color copier IMAGIO COLOR 2800 (from Ricoh Co., Ltd.), and a monochrome image having an image area of 7% was continuously printed on 100,000 sheets of paper under a high-temperature and high-humidity condition (40° C., 90% RH) and a low-temperature and low-humidity condition (10° C., 15% RH). A portion of the developer was collected at every 1000 sheets of printing, and subjected to measurement of toner charge quantity by a blow off method. More specifically, 10 g of the toner and 100 g of a ferrite carrier were contained in a stainless pot occupying 30% of the volume, and agitated for 10 minutes at a revolution of 100 rpm. The mixture was subjected to measurement using a blow off instrument TB-200. In Table 3, charge stability is evaluated by the variation in charge quantity as follows.

Rank A: The variation is less than 5 μC/g.

Rank B: The variation is not less than 5 μC/g and less than 10 μC/g.

Rank C: The variation is not less than 10 μC/g.

### Evaluation of Minimum Fixable Temperature

The minimum fixable temperature of a toner was evaluated using a copier MF2200 (from Ricoh Co., Ltd.) employing a fixing roller of TEFLON®. A toner image was formed on a paper TYPE 6200 (from Ricoh Co., Ltd.). The linear speed, surface pressure, and nip width were set to 120-150 mm/sec, 1.2 kgf/cm², and 3 mm, respectively. The minimum fixable temperature is graded into the following five ranks.

Rank A: Less than 140° C.

Rank B: Not less than 140° C. and less than 150° C.

Rank C: Not less than 150° C. and less than 160° C.

Rank D: Not less than 160° C. and less than 170° C.

Rank E: Not less than 170° C.

### Evaluation of Maximum Fixable Temperature

The maximum fixable temperature of a toner was evaluated using a copier MF2200 (from Ricoh Co., Ltd.) employing a fixing roller of TEFLON®. A toner image was formed on a paper TYPE 6200 (from Ricoh Co., Ltd.). The linear speed, surface pressure, and nip width were set to 50 mm/sec, 2.0 kgf/cm², and 4.5 mm, respectively. The maximum fixable temperature is graded into the following five ranks.

Rank A: Not less than 200° C.

Rank B: Not less than 190° C. and less than 200° C.

Rank C: Not less than 180° C. and less than 190° C.

Rank D: Not less than 170° C. and less than 180° C.

Rank E: Less than 170° C.

### Evaluation of Heat-Resistant Storage Stability

A toner was stored for 8 hours at 50° C., and sieved for 2 minutes with a 42 mesh. Heat-resistant storage stability was evaluated by the residual rate of the toner remaining on the sieve and graded as follows.

Rank A: The residual rate was less than 10%.

Rank B: The residual rate was not less than 10% and less than 20%.

Rank C: The residual rate was not less than 20% and less than 30%.

Rank D: The residual rate was not less than 30%.

Table 3 shows that the exemplary toners produced good results in all the evaluations.

The toner of Comparative Example in which the toner is manufactured by an apparatus without the heat insulating part produced poor results in the evaluations of image granularity and sharpness, background fouling, toner scattering, and fixability. This is because the bottom of the supply part was burnt due to toner accumulation.

Additional modifications and variations of the present invention are possible in light of the above teachings. It is therefore to be understood that within the scope of the appended claims the invention may be practiced other than as specifically described herein.

What is claimed is:

1. A method of manufacturing toner, comprising:
preparing a first liquid by dissolving or dispersing toner components in an organic solvent, the toner components including a colorant, a release agent, and one or both of a binder resin and a precursor thereof;
preparing a second liquid by emulsifying the first liquid in an aqueous medium, the second liquid having a viscosity of from 50 to 800 mPa·sec when measured with a Brookfield viscometer at a revolution of 60 rpm and a temperature of 25° C.; and
evaporating the organic solvent from the second liquid, the evaporating including:
flowing down the second liquid as a liquid film from a supply part along an inner wall surface of a pipe depressurized to 70 kPa or less in substantially a vertical direction; and
heating the liquid film at not higher than a glass transition temperature of the binder resin by contact with the inner wall surface of the pipe in a heating part,
wherein a heat insulating part is provided between the supply part and the heating part.

2. The method of manufacturing toner according to claim 1, wherein the precursor comprises a compound having an active hydrogen group and a polymer having a functional group reactive with the active hydrogen group.

3. The method of manufacturing toner according to claim 2, wherein the compound having an active hydrogen group reacts with the polymer having a functional group reactive with the active hydrogen group while the second liquid is prepared.

4. The method of manufacturing toner according to claim 2, wherein the polymer having a functional group reactive with the active hydrogen group is a polyester having an isocyanate group.

5. The method of manufacturing toner according to claim 4, wherein the polyester having an isocyanate group has a weight average molecular weight of from 3,000 to 20,000.

6. The method of manufacturing toner according to claim 1, wherein a lower end of the pipe projects downward from the heating part.

7. The method of manufacturing toner according to claim 1, wherein the following relationships are satisfied:
T1≦T2
T2<Tg<T3
wherein T1 (° C.) represents a supply temperature of the second liquid, T2 (° C.) represents a temperature of the supply part, T3 (° C.) represents an emission temperature of a heat source, and Tg (° C.) represents a glass transition temperature of the binder resin.

8. The method of manufacturing toner according to claim 1, wherein, in the evaporating of the organic solvent from the second liquid, a portion of the second liquid from which the organic solvent is evaporated is discharged and returned to the supply part to form the liquid film together with the second liquid from which the organic solvent is not evaporated.

9. The method of manufacturing toner according to claim 8, wherein the following relationships are satisfied:
A+C=B
A=D+E
1.5A≦B≦20A
wherein A (kg/h) represents a supply flow rate of the second liquid from which the organic solvent is not evaporated, B (kg/h) represents a flow rate of the liquid film flowing down the inner wall surface of the pipe, C (kg/h) represents a flow rate of the portion of the discharged second liquid from which the organic solvent is evaporated that returns to the supply part, D (kg/h) represents a flow rate of a remaining discharged second liquid from which the organic solvent is evaporated that does not return to the supply part, and E (kg/h) represents an amount of the organic solvent evaporated from the second liquid.

10. The method of manufacturing toner according to claim 1, wherein the toner components further include a modified layered inorganic mineral in which metallic cations are at least partially exchanged with an organic cation.

11. The method of manufacturing toner according to claim 10, wherein the modified layered inorganic mineral is mixed with the binder resin to be a composite before preparing the first liquid,
the modified layered inorganic mineral has a volume average particle diameter of from 0.1 to 0.55 μm in the composite, and
the composite includes 0 to 15% by volume of particles of the modified layered inorganic mineral having a volume average particle diameter of 1 μm or more.

12. The method of manufacturing toner according to claim 10, wherein the toner includes the modified layered inorganic mineral in an amount of from 0.1 to 5% by weight.

13. The method of manufacturing toner according to claim 10, wherein the organic cation is a quaternary ammonium ion.

14. The method of manufacturing toner according to claim 1, wherein the binder resin comprises a polyester.

15. The method of manufacturing toner according to claim 14, wherein the binder resin comprises the polyester in an amount of from 50 to 100% by weight.

16. The method of manufacturing toner according to claim 14, wherein THF-soluble components in the polyester have a weight average molecular weight of from 1,000 to 30,000.

17. The method of manufacturing toner according to claim 14, wherein the polyester has a glass transition temperature of from 35 to 65° C.

18. A toner manufactured by the method according to claim 1.
